(19) United States
(12) Patent Application Publication
(10) Pub. No.: US 2016/0189444 A1
(43) Pub. Date: Jun. 30, 2016

(54) SYSTEM AND METHOD TO ORCHESTRATE IN-VEHICLE EXPERIENCES TO ENHANCE SAFETY

(71) Applicant: CloudCar, Inc., Mountain View, CA (US)

(72) Inventors: Ajay Madhok, Los Altos, CA (US); Evan Malahy, Santa Clara, CA (US); Ron Morris, Seattle, WA (US)

(21) Appl. No.: 15/042,092

(22) Filed: Feb. 11, 2016

Related U.S. Application Data
(63) Continuation-in-part of application No. 13/730,922, filed on Dec. 29, 2012.
(60) Provisional application No. 62/115,386, filed on Feb. 12, 2015.

(51) Int. Cl. G07C 5/02; G07C 5/08

(52) U.S. Cl. CPC G07C 5/02; G07C 5/08

(57) ABSTRACT

A system and method to orchestrate in-vehicle experiences to enhance safety are disclosed. A particular embodiment includes: queuing a collection of contextually relevant portions of information gathered from one or more vehicle-connectable data sources; selecting one or more of the relevant portions of information based on a vehicle's current context or a vehicle driver's current context; determining an active workload of the vehicle driver in the current context; determining a preferred manner for presenting the selected portions of information to the vehicle driver based on the active workload of the vehicle driver and the current context; and presenting the selected portions of information to the vehicle driver using the determined preferred manner.

### PRIORITY PATENT APPLICATION

This is a continuation-in-part patent application drawing priority from U.S. patent application Ser. No. 13/730,922; filed Dec. 29, 2012. This is also a non-provisional patent application drawing priority from U.S. provisional patent application Ser. No. 62/115,386; filed Feb. 12, 2015. This present patent application draws priority from the referenced patent applications. The entire disclosure of the referenced patent applications is considered part of the disclosure of the present application and is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2010-2016, CloudCar Inc., All Rights Reserved.

### TECHNICAL FIELD

This patent document pertains generally to tools (systems, apparatuses, methodologies, computer program products, etc.) for allowing electronic devices to share information with each other, and more particularly, but not by way of limitation, to a system and method to orchestrate in-vehicle experiences to enhance safety.

### BACKGROUND

An increasing number of vehicles are being equipped with one or more independent computer and electronic processing systems. Certain of the processing systems are provided for vehicle operation or efficiency. For example, many vehicles are now equipped with computer systems for controlling engine parameters, brake systems, tire pressure and other vehicle operating characteristics. A diagnostic system may also be provided that collects and stores information regarding the performance of the vehicle's engine, transmission, fuel system and other components. The diagnostic system can typically be connected to an external computer to download or monitor the diagnostic information to aid a mechanic during servicing of the vehicle.

Additionally, other processing systems may be provided for vehicle driver or passenger comfort and/or convenience. For example, vehicles commonly include navigation and global positioning systems and services, which provide travel directions and emergency roadside assistance. Vehicles are also provided with multimedia entertainment systems that include sound systems, e.g., satellite radio, broadcast radio, compact disk and MP3 players and video players. Still further, vehicles may include cabin climate control, electronic seat and mirror repositioning and other operator comfort features.

However, each of the above processing systems is independent, non-integrated and incompatible. That is, such processing systems provide their own sensors, input and output devices, power supply connections and processing logic. Moreover, such processing systems may include sophisticated and expensive processing components, such as application specific integrated circuit (ASIC) chips or other proprietary hardware and/or software logic that are incompatible with other processing systems in the vehicle or the surrounding environment.

Additionally, consumers use their smart phones for many things (there is an app for that). They want to stay connected and bring their digital worlds along when they are driving a vehicle. They expect consistent experiences as they drive. But, smartphones and vehicles are two different worlds. While the smartphone enables their voice and data to roam with them, their connected life experiences and application (app)/service relationships do not travel with them in a vehicle.

Consider a vehicle as an environment that has ambient intelligence by virtue of its sensory intelligence, IVI (in-vehicle infotainment) systems, and other in-vehicle computing or communication devices. The temporal context of this ambient intelligent environment of the vehicle changes dynamically (e.g., the vehicle's speed, location, what is around the vehicle, weather, etc. changes dynamically) and the driver may want to interact in this ambient intelligent environment with mobile apps and/or cloud based services. However, conventional systems are unable to react and adapt to these dynamically changing environments.

As computing environments become distributed, pervasive and intelligent, multi-modal interfaces need to be designed that leverage the ambient intelligence of the environment, the available computing resources (e.g., apps, services, devices, in-vehicle processing subsystems, an in-vehicle heads-up display (HUD), an extended instrument cluster, a Head-Unit, navigation subsystems, communication subsystems, media subsystems, computing resources on mobile devices carried into a vehicle or mobile devices coupled to an in-vehicle communication subsystem, etc.), and the available interaction resources. Interaction resources are end points (e.g., apps, services, devices, etc.) through which a user can consume (e.g., view, listen or otherwise experience) output produced by another resource. However, is difficult to design a multi-modal experience that adapts to a dynamically changing environment. The changes in the environment may be the availability or unavailability of a resource, such as an app, service or a device, a change in the context of the environment, or temporal relevance. Given the dynamic changes in the ambient intelligent environment, the user experience needs to transition smoothly from one context of use to another context while conforming to the constraints and maintaining consistent usability and relevance.

Today, there is a gap between the actual tasks a user should be able to perform and the user interfaces exposed by the applications and services to support those tasks while conforming to the dynamically changing environments and related safety constraints. This gap exists because the user interfaces are typically not designed for dynamically changing environments and they cannot be distributed across devices in ambient intelligent environments.

There is a need for design frameworks that can be used to create interactive, multi-modal user experiences for ambient intelligent environments. The diversity of contexts of use such user interfaces need to support require them to work across the heterogeneous interaction resources in the environment and provide dynamic binding with ontologically diverse applications and services that want to be expressed.

Some conventional systems provide middleware frameworks that enable services to interoperate with each other while running on heterogeneous platforms; but, these conventional frameworks do not provide adaptive mapping between the actual tasks a user should be able to perform and the user interfaces exposed by available resources to support those tasks.

There is no framework available today that can adapt and transform the user interface for any arbitrary service at run-time to support a dynamically changing environment. Such a framework will need to support on-the-fly composition of user interface elements, such that the overall experience presents only contextually relevant information (as opposed to a fixed taxonomy), optimizing the available resources while conforming to any environmental constraints. Further, the framework must ensure that the resulting user interface at any point in time is consistent, complete and continuous (switching input/output—I/O modalities and user interfaces increases users' workload); consistent because the user interface must use a limited set of interaction patterns consistently to present the interaction modalities of any task; complete because all interaction tasks that are necessary to achieve a goal must be accessible to the user regardless of which devices may be available in the environment; continuous because the framework must orchestrate and manage all transitions as one set of tasks in a progression to another set of tasks. No such framework exists today that visualizes and distributes user interfaces dynamically to enable the user to interact with an ambient computing environment by allocating tasks to interaction resources in a manner that the overall experience is consistent, complete, and continuous. In summary, there is no framework that provides one, unified experience to enable a large variety of driver-centric (or car-centric) jobs to be done safely (while driving).

When vehicles were not network-connected, they only had to display the vehicle related information, e.g., fuel level, speed, engine temperature, etc. But as vehicles get network-connected, the amount of information that consumers expect to be presented has increased. In fact, consumers expect that their apps, such as calendar, messaging, social, and other services they use at work and at home will continue to keep them informed while they are driving. Likewise, they expect that they could get things done in a connected vehicle as they do today in other network-connected environments—by using apps on their mobile whether it is navigating to a place, playing media, or getting some information from a search engine like Google® or an app like Yelp®.

If safety was not an issue, this push and pull of information from apps and services would not be a problem. But in a moving vehicle, a driver's visual, cognitive, and manual workload increases if they have to interact with the mobile device and view the dynamically changing information being presented to them. This driver workload also increases if they have to make decisions based on that information while they are driving. In simple terms, any information that is presented to a driver, by an in-vehicle application or an external service or a service endpoint, competes for the driver's attention.

In many cases, information pushed to a driver in a vehicle environment can be a safety hazard. For example, consider a young driver who follows tens of celebrities on Twitter® and has hundreds of Facebook® friends. It is easy to imagine that their phone would buzz and beep every few minutes with a Tweet or a Facebook update or an incoming Short Message Service (SMS) message. These inbound notifications get generated asynchronously and get delivered to their mobile device regardless of where they are or the nature of their driving context. They might be crossing a school or a traffic light or maneuvering into a highway; but, the notification will get delivered and will be a source of distraction to the driver. This is because the information delivered may have two or three lines (up to 140 characters) of text and reading the text in a moving vehicle could take a few seconds, at the cost of looking away from the road onto the vehicle display or mobile device. Further, if the driver has to interact with the information, such as go to the next message or reply to an inbound notification, the driver's manual, visual, and cognitive workload is also increased. Similarly, when a driver uses an app (e.g., an application on the mobile device or from their network-connected vehicle) to pull information, the driver workload is increased. The process of pulling information, selecting the app to use, getting to the right menu or button to make the request in the app, making the request for the information (keying in or speaking), making sense of the results, selecting the right result, etc. requires driver attention, manual and visual coordination, which makes these distractions unsafe while driving.

Regulators like NHTSA (National Highway Traffic Safety Administration) have been aware of this problem and have suggested regulation and guidelines for the flow and control of information in a driving context. In response to consumer demand, vehicle OEMs (original equipment manufacturers) have continued to evolve their solutions to enable network-connected vehicles through in-vehicle experiences that make this push and pull of information possible from network-connected vehicles.

Today, there are two dominant approaches that vehicle OEMs have taken. One approach mirrors the smartphone, where the vehicle's IVI system essentially becomes a receptacle for whatever is presented on the smartphone by the OS (operating system) or an app. The other approach is to embed a set of hand-picked applications within a vehicle's IVI platform or create applications natively for the vehicle's IVI platform. The second approach, OEMs hoped, would give them more control of the application behavior (e.g., visual design and interaction model) as opposed to an independent app downloaded from the app store, which may or may not conform to any safety guidelines.

We find that both approaches are fundamentally unsafe because of three common issues. The first issue is that both approaches present the icons for the apps that are available to the user. The apps may be the ones that the user has installed on their smartphone (mirroring the sea of icons from the phone to the vehicle) or displaying the set of apps that are natively available in the vehicle. When presented with a sea of icons in a moving vehicle, just selecting the right app to launch requires a level of manual and visual coordination that is greater than the safely available attention resources available to a driver. The second issue is that when an app is launched, whether it is running on the phone and mirrored into the vehicle (approach one) or running natively in the vehicle (approach two), the app comes with its own unique interface, that is typically designed to engage the user. This means to get things done, the user has to interact with a variety of different user interfaces (UIs), each with their own information flow and interaction patterns. Switching between views of the app and between apps changes the user's context and increases the driver's cognitive, visual and manual workload beyond safe limits. The third problem is that interoperating between multiple apps, for example Search and Navigation, requires interactions that need manual and visual co-ordination over and above what was needed to interact with just one app, thus further significantly increasing the driver's workload.

Consumers want their vehicles to be an extension of their digital and social media lifestyles. They want their smartphone applications to be accessible in their vehicles. However, driving a vehicle safely involves constant and complex coordination between mind and body that makes any handling of the phone, including interacting with apps, dangerous. There is a need for a solution that enables consumers to continue to get their jobs done safely, the jobs for which they may safely use their smartphones in their vehicles.

### SUMMARY

A system and method to orchestrate in-vehicle experiences to enhance safety are disclosed herein in various example embodiments. An example embodiment provides a user experience framework that can be deployed to deliver consistent experiences that adapt to the changing context of a vehicle and the user's needs and is inclusive of any static and dynamic applications, services, devices, and users. Apart from delivering contextually relevant and usable experiences, the framework of an example embodiment also addresses distracted driving, taking into account the dynamically changing visual, manual and cognitive workload of the driver.

The framework of an example embodiment provides a multi-modal and integrated experience that adapts to a dynamically changing environment. The changes in the environment may be caused by the availability or unavailability of a resource, such as an app, service or a device; or a change in the temporal context of the environment; or a result of a user's interaction with the environment. As used herein, temporal context corresponds to time-dependent, dynamically changing events and signals in an environment. In a vehicle-related embodiment, temporal context can include the speed of the vehicle (and other sensory data from the vehicle, such as fuel level, etc.), location of the vehicle, local traffic at that moment and place, local weather, destination, time of the day, day of the week, etc. Temporal relevance is the act of making sense of these context-changing events and signals to filter out signal from noise and to determine what is relevant in the here and now. The various embodiments described herein use a goal-oriented approach to determine how a driver's goals (e.g., destination toward which the vehicle is headed, media being played/queued, conversations in progress/likely, etc.) might change because of a trigger causing a change in the temporal context. The various embodiments described herein detect a change in temporal context to determine (reason and infer) what is temporally relevant. Further, some embodiments infer not only what is relevant right now, but also predict what is likely to be relevant next. Given the dynamic changes in the ambient intelligent environment, the user experience transitions smoothly from one context of use to another context while conforming to the constraints and maintaining consistent usability and relevance.

The framework of an example embodiment also adapts to a dynamically changing environment as mobile devices, and the mobile apps therein, are brought into the environment. Because the presence of new mobile devices and mobile apps brought into the environment represent additional computing platforms and services, the framework of an example embodiment dynamically and seamlessly integrates these mobile devices and mobile apps into the environment and into the user experience. In a vehicle-related environment, an embodiment adapts to the presence of mobile devices and mobile apps as these devices are brought within proximity of a vehicle; and the apps are active and available on the mobile device. The various embodiments integrate these mobile devices/apps into the vehicle environment and with the other vehicle computing subsystems available therein. This integration is non-trivial as there may be multiple mobile apps that a user might want to consume; but, each mobile app may be developed by potentially different developers who use different user interfaces and/or different application programming interfaces (APIs). Without the framework of the various embodiments, the variant interfaces between mobile apps would cause the user interface to change completely when the user switched from one app or one vehicle subsystem to another. This radical switch in the user interface occurs in conventional systems when the user interface of a foreground application completely takes over all of the available interaction resources. This radical switch in the user interface can be confusing to a driver and can increase the driver's workload, which can lead to distracted driving as the driver tries to disambiguate the change in the user interface context from one app to another. In some cases, multiple apps cannot be consumed as such by the driver in a moving vehicle, if the user interface completely changes from one app to the next. For example, the duration and frequency of interactions required by the user interface may make it unusable in the context of a moving vehicle. Further, when the driver is consuming a given application, a notification from another service or application can be shown overlaid on top of the foreground application. However, consuming the notification means switching to the notifying app where the notification can be dealt with/actioned. Context switching of apps, again, increases the driver workload as the switched app is likely to look and feel differently and to have its own interaction paradigm.

The various embodiments described herein eliminate this radical user interface switch when mobile devices/apps are brought into the environment by providing an inclusive framework to consume multiple applications (by way of their intents) in one, integrated user experience. The various embodiments manage context switching, caused by application switching, through the use of an integrated user experience layer where several applications can be plugged in simultaneously. Each application can be expressed in a manner that does not consume all the available interaction resources. Instead, a vertical slice (or other user interface portion or application intent) from each of the simultaneously in-use applications can be expressed using a visual language and interaction patterns that make the presentation of each of the simultaneously in-use tasks homogenous, thereby causing the user experience to be consistent across each of the in-use applications.

The embodiments described herein specify the application in terms of its intent(s), that is, the set of tasks that help a user accomplish a certain goal. These intents are either explicitly requested by the user (for example, Navigate to 555 Main Street, SFO) or implicitly inferred by the framework based on user's temporal context (for example, user's destination is 100 miles away, gas range is 50 miles, hence the inferred intent is to show h gas stations along the route). The intent could be enabling a user task (or an activity), a service, or delivering a notification to the user. The framework publishes user intents (both explicitly requested and implicitly inferred) to participating applications and services which subscribe to the user intents. Likewise, applications or services can publish notification intents that the framework can subscribe to. The Car publishes Context intents (Telemetry Data) that are subscribed to by the framework. This makes intents the atomic unit that is exchanged in both directions—between the framework and participating end-points (apps and services). The intent is specified as {Topic, Domain, Key} and sent as data in application messages, which are pushed to the framework or pulled/requested by the framework. These messages can carry the information required to understand and fulfill the temporal intent in terms of the object (e.g., the noun or content) of the application, the input/output (I/O) modality of the intent/task at hand (e.g., how to present the object to the user), and the actions (e.g., the verbs associated with the application) that can be associated with the task at hand (the intent). As such, an intent as used herein can refer to a message, event, a data object, a request, or a response associated with a particular task, application, or service in a particular embodiment. An intent can be a first-class object used to request a job-to-be-done, for sharing context, or delivering results. One example embodiment provides a Service Creation interface that enables the developer of the application or service to describe their application's intent so that the application's intent can be handled/processed at run-time. The description of the application's intent can include information, such as the Noun (object) upon which the application will act, the Verbs or the action or actions that can be taken on that Noun, and the Interaction and Launch Directives that specify how to interact with that object and launch a target action or activity (e.g., the callback application programming interface—API to use). In other words, the Service Creation interface enables a developer to describe their application in terms of intents and related semantics using a controlled vocabulary of Nouns and Verbs that represent well-defined concepts specified in an environment-specific ontology. Further, an application intent description can also carry metadata, such as the application's domain or category (Media, Places, People, etc), context of use (Topic), criticality, time sensitivity, etc. enabling the system to deal appropriately with the temporal intent of the application.

The temporal intent description can be received by subscribing endpoints (framework, apps, services) through a particular embodiment as messages. The metadata in a fulfilled intent message can be used to aggregate, de-dupe, filter, order, and queue the received messages for further processing. It is then ranked for relevancy and the top most relevant fulfilled intents enter the attention queue. The further processing can include transforming the messages appropriately for presentation to the user so that the messages are useful, usable, and desirable. In the context of a vehicle, the processing can also include presenting the messages to the user in a manner that is vehicle-appropriate using a consistent visual language with minimal interaction patterns (keeping only what is required to disambiguate the interaction) that are carefully designed to minimize driver distraction. The processing of ordered application intent description messages includes mapping the particular application intent descriptions to one or more tasks that will accomplish the described application intent. Further, the particular application intent descriptions can be mapped onto abstract I/O objects. At run-time, the abstract I/O objects can be visualized by mapping the abstract I/O objects onto available concrete I/O resources. The various embodiments also perform processing operations to determine where, how, and when to present application information to the user in a particular environment, so that the user can use the application, obtain results, and achieve their goals. Any number of application intent descriptions, from one or more applications, can be requested or published to the various embodiments for concurrent presentation to a user. The various intents received from one or more applications get filtered and ordered based on the metadata, such as criticality and relevance based on the knowledge of the temporal context. The various embodiments compose the application intent descriptions into an integrated user experience employing the environmentally appropriate visual language and interaction patterns. Application intent transitions and orchestration are also handled by the various embodiments. At run-time, the application intent descriptions can be received by the various embodiments using a services gateway as a message or notification receiver.

Further, the experience framework as described herein manages transitions caused by messages, notifications, and changes in the temporal context. The experience framework of an example embodiment orchestrates the tasks that need to be made available simultaneously for a given temporal context change, manages any state transitions, such that the experience is consistent, complete, and continuous. The experience framework manages these temporal context changes through an equivalent of a composite or multi-modal dialog as opposed to a modal user interface that the foreground application presents in conventional systems.

In various example embodiments described herein, the disclosed embodiments address this consumer need to stay informed (e.g., by information being pushed to them via a network) and to pull information (e.g., to get things done using apps and services). In the various example embodiments, a new system and method is disclosed to push and pull information from apps and services in a manner that addresses driver and vehicle safety first. The various example embodiments are designed with the basic principle that the only safe way to push and pull information in a moving vehicle using the smart phone is to keep the phone in the driver's pocket and not interact with it directly. The various example embodiments described herein create an in-vehicle experience that is designed to deliver glanceable views of information, keeping them within safety limits, and enable interaction with the information using the primary inputs available in the vehicle (e.g., up, down, left, right, select, and microphone or mic buttons that are typically available on a conventional vehicle steering wheel). The various example embodiments described herein provide an in-vehicle experience framework that enables the safe push and pull of information in a network-connected vehicle.

### BRIEF DESCRIPTION OF THE DRAWINGS

The various embodiments is illustrated by way of example, and not by way of limitation, in the figures of the accompanying drawings in which:

FIG. 1 illustrates an example set of components of the adaptive experience framework of an example embodiment;

FIG. 2 illustrates a task set in an example embodiment of the adaptive experience framework;

FIG. 3 illustrates a task hierarchy in a task set of an example embodiment of the adaptive experience framework;

FIG. 4 illustrates input interaction resources and output interaction resources of an example embodiment of the adaptive experience framework;

FIG. 5 illustrates the components of a task model in an example embodiment of the adaptive experience framework;

FIG. 6 illustrates a notification module of an example embodiment of the adaptive experience framework;

FIG. 7 illustrates a reference model of an example embodiment of the adaptive experience framework;

FIG. 8 illustrates a reference architecture of an example embodiment of the adaptive experience framework;

FIG. 9 illustrates the processing performed by the task model in an example embodiment;

FIGS. 10 and 11 illustrate the processing performed by the adaptive experience framework in an example embodiment;

FIG. 12 illustrates an example of the adaptive experience framework in a vehicle environment in an example embodiment;

FIG. 13 illustrates the push and pull of information in an example embodiment;

FIG. 14 illustrates the contextual relevance processing in an example embodiment;

FIG. 15 illustrates the structure of the orchestration state machine or module in an example embodiment;

FIG. 16 illustrates the structure of the orchestration module in an example embodiment;

FIG. 17 illustrates the intents data distribution service in an example embodiment;

FIG. 18 illustrates the intents data distribution service in an example embodiment with detail on the user requested intents and inferred intents;

FIG. 19 illustrates the intents data distribution service in an example embodiment with detail on the fulfilled and suggested intents;

FIG. 20 illustrates the services structure of an example embodiment;

FIG. 21 illustrates the experience structure of an example embodiment enabling the creation of custom user interfaces;

FIG. 22 illustrates the smart vehicle platform of an example embodiment;

FIG. 23 illustrates an example of adding a service in an example embodiment;

FIG. 24 is a processing flow chart illustrating an example embodiment of a system and method to orchestrate in-vehicle experiences to enhance safety; and

FIG. 25 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

As described in various example embodiments, a system and method to orchestrate in-vehicle experiences to enhance safety are described herein. In one particular embodiment, a system and method to orchestrate in-vehicle experiences to enhance safety is provided in the context of a cloud-based vehicle information and control ecosystem configured and used as a computing environment with access to a wide area network, such as the Internet. However, it will be apparent to those of ordinary skill in the art that the system and method to orchestrate in-vehicle experiences to enhance safety as described and claimed herein can be implemented, configured, deployed, and used in a variety of other applications, systems, and ambient intelligent environments. Each of the service modules, models, tasks, resources, or components described below can be implemented as software components executing within an executable environment of the adaptive experience framework. These components can also be implemented in whole or in part as network cloud components, remote service modules, service-oriented architecture components, mobile device applications, in-vehicle applications, hardware components, or the like for processing signals, data, and content for the adaptive experience framework. In one example embodiment, one or more of the service modules of the adaptive experience framework are executed in whole or in part on a computing platform in a vehicle. One or more of the service modules of the adaptive experience framework can also be executed in whole or in part on a computing platform (e.g., a server or peer-to-peer node) in the network cloud 616. In another example embodiment, one or more of the service modules of the adaptive experience framework are executed in whole or in part on a computing platform of a mobile device, such as a mobile telephone (e.g., iPhone™, Android™ phone, etc.) or a mobile app executing therein. Each of these framework components of an example embodiment is described in more detail below in connection with the figures provided herein.

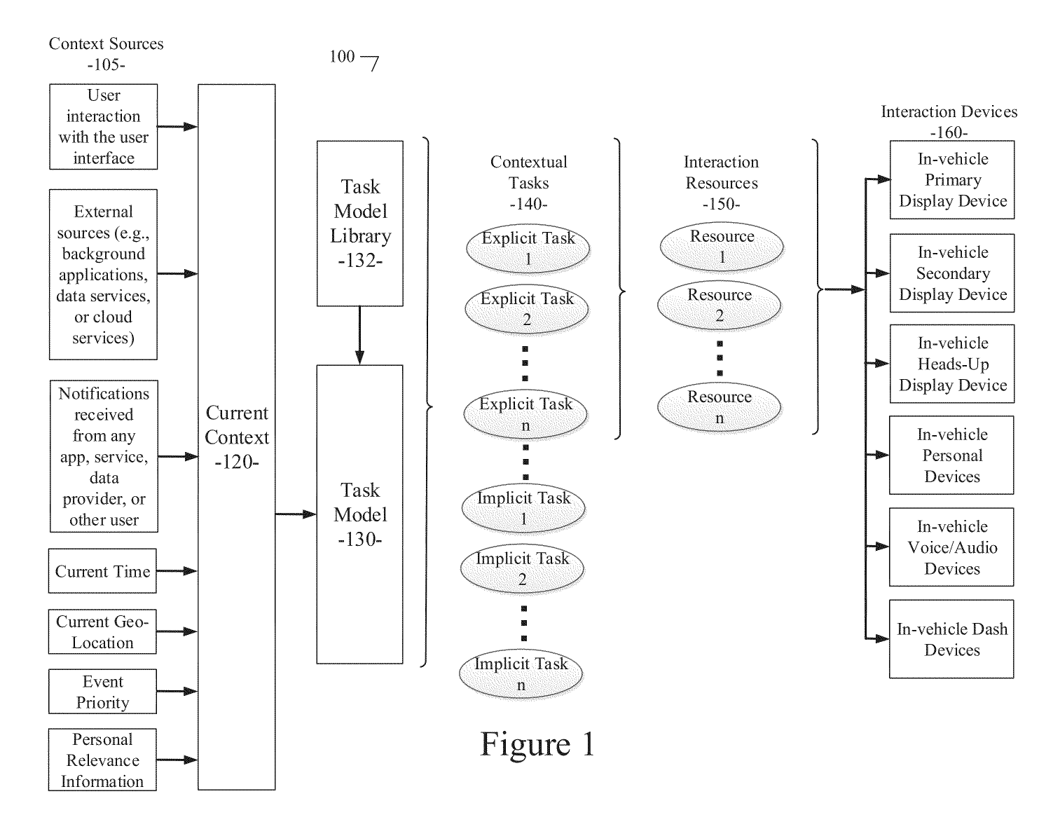

Referring now to FIG. 1, the adaptive experience framework system 100 of an example embodiment is shown in a cloud-based vehicle information and control ecosystem. In the application with a vehicle ecosystem, the adaptive experience framework system 100 takes into account the driver's needs and goals in a given temporal context 120, mapping these driver needs and goals to a set of contextual tasks 140, and then mapping the contextual tasks to available interaction resources 150 and distributing them across multiple interaction devices 160 in the vehicle ecosystem, orchestrating and managing transitions as the tasks progress. As a result, the driver is presented with one integrated experience. Further, the adaptive experience framework system 100 adapts that integrated experience to change or transition as the context in the vehicle ecosystem or the driver context changes, such that the integrated experience remains consistent, complete, and continuous while addressing distracted driving.

The adaptive experience framework system 100 of an example embodiment provides an integrated experience, because the framework 100 de-couples the native user interfaces of an app or service from its presentation in the context of the vehicle. Instead of showing whole or entire apps or services with their distinct interfaces, the framework 100 presents vertical slices (or other user interface portions), described herein as intents, from each of the simultaneously in-use apps or services expressed using a visual language and interaction patterns that make presentation of these intents from multiple apps or services homogenous. The framework 100 presents the user interface portions or application/service intents that are contextually relevant to the driver at a particular time. The framework 100 determines which of the available or asserted application/service intents are contextually relevant by determining the goals of the driver in a given context; and by determining the tasks that are associated with the available or asserted application/service intent in the particular context. The tasks determined to be associated with the available or asserted application/service intent in the particular context are grouped into a task set that represents the tasks that need to be made concurrently available to fulfill those goals. Then, the framework 100 expresses the relevant task set simultaneously in an integrated experience to maintain interaction and presentation consistency across tasks that may use different apps or methods in multiple apps to fulfill them.

The framework 100 computes the set of tasks 140 that need to be made available in a given context (e.g., such as the tasks that are associated with the available or asserted application/service intent in the particular context) 120 and maps the set of tasks 140 onto interaction resources 150 supporting the temporally relevant tasks, visualizes the set of tasks 140 using concrete interfaces and deploys the set of tasks 140 on available interaction devices 160 using the interaction resources 150. A mapping and planning process is used by a task model 130 to compute an efficient execution of the required tasks 140 with the interaction resources 150 that are available. Specifically, the task model 130 receives an indication of context changes captured in the current context 120 and performs a set of coordinated steps to transition a current state of the user experience to a new state that is appropriate and relevant to the changed context. In order to detect context changes, the current context 120 is drawn from a variety of context sources 105, including: the user's interaction with the interface; the external (to the user interface) context changes and notifications received from any app, service, data provider, or other user system that wishes to present something to the user/driver; the current time and geo-location; the priority or criticality of received events or notifications; and personal relevance information related to the user/driver. The notifications are received as abstract signals, a message that has a well-defined structure that defines the domain, content and actions associated with the notification. The task model 130 can transform the abstract notification into one or more tasks 140 that need to be performed in a given context 120 corresponding to the notification. The processing of notifications is described in more detail below. Likewise, the task model 130 can identify other tasks 140 that need to be made available or expressed in the new context 120 within a given set of constraints, such as the available interaction devices 160 and their interaction and presentation resources 150.

The task model 130 can interpret any specified application intent in terms of two types of tasks 140 (e.g., explicit tasks and implicit tasks) that can be performed in different contexts of use. Implicit tasks are abstract tasks that do not require any interaction resources 150 and can be fulfilled in the background, such as querying a service or a data/knowledge endpoint. Explicit tasks require a concrete interaction resource 150 to be presented and thus explicit tasks have their accompanying interaction modality. An application intent (and its related task set) 140 that can be used, for example, to present a queued media item (e.g., a song selection) is an example of an explicit task. In this example, the queued media needs an interaction device (e.g., the audio sound system) to play the song selection. Another example of an explicit task is an application intent that corresponds to a presentation of a notification to notify the user of a certain event that occurred in an associated application. These explicit tasks either require an interaction device 160 to present output to a user or the explicit task needs the user to take some action, such as make a selection from a given set of choices. Both implicit and explicit tasks might require a specific method or API or a callback function of an application or service to be invoked.

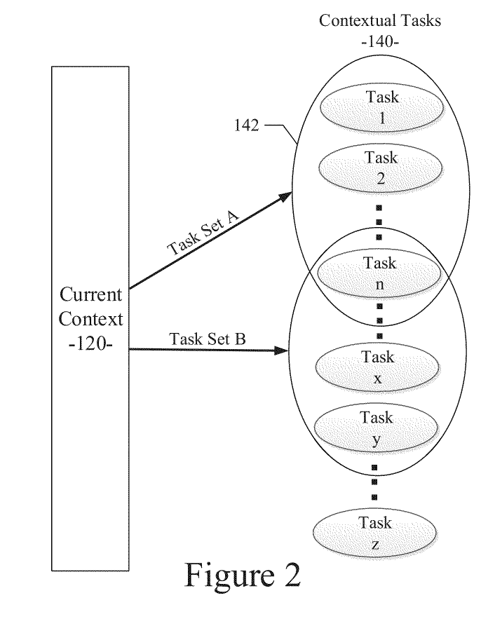

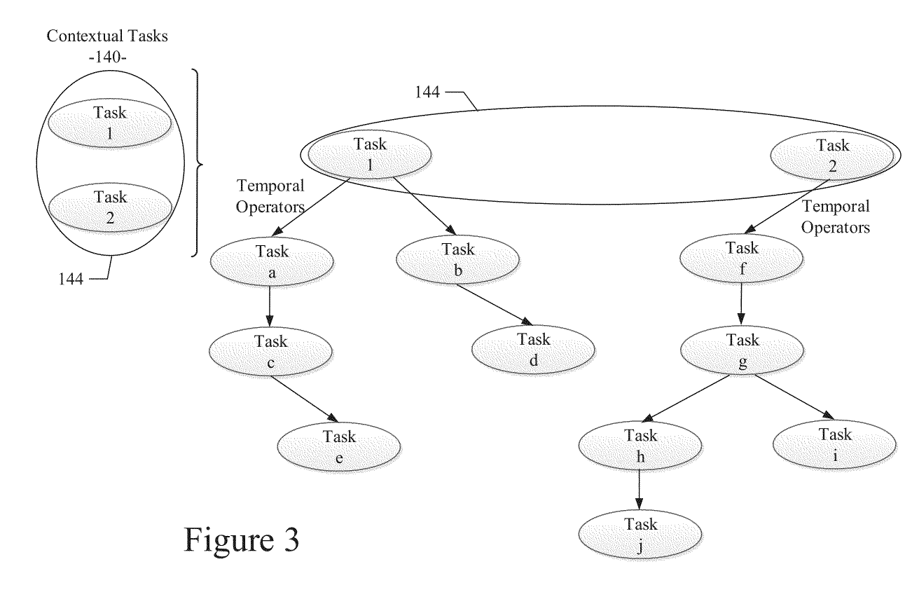

Referring now to FIGS. 2 and 3, given that a context 120 may require multiple application intents (and their related task sets) 140 to be performed concurrently, a grouping of required tasks 140 for the context 120 can be aggregated into a task set, such as task set 142 in FIG. 2 or 144 in FIG. 3, which comprises all the tasks 140 that have the same level in a hierarchy of decomposition of goals, but may have different relevance and information hierarchy. An example of a task hierarchy is shown in FIG. 3. The task hierarchy of the task set defines the set of tasks to be performed to transition to the new context and to meet the goals specified by a user or the system. As shown in FIG. 3, the framework 100 connects the tasks 140 in a task set, such as task set 144, using temporal operators, such as choice, independent concurrency, concurrency with information exchange, disabling, enabling, enabling with information exchange, suspend/resume and order independency. As a result, the execution of the tasks in the task hierarchy can be performed efficiently, yet controlled by the framework 100.

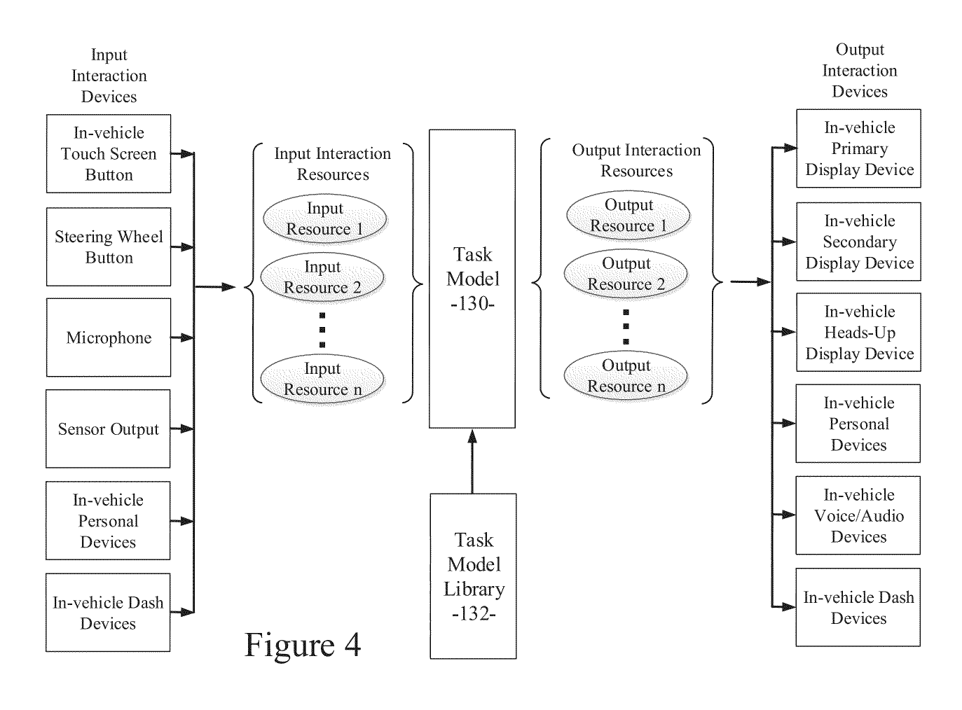

Referring again to FIG. 1, the framework 100 includes a library of task models 132, wherein each task model describes or identifies the tasks 140 a user may need to perform in different contexts 120 of use. Each task model also creates placeholders for other tasks that may be required based on an incoming notification (from other apps or services). To do this, all notifications are accompanied by a task description. The task model 130 expresses each task 140 using an abstract interaction object that is independent of any interaction device to capture the interaction modalities of the task. At run-time, the task 140 and its associated abstract interaction object can be realized through concrete interaction objects using available interaction resources 150. An interaction resource is an input/output (I/O) channel that is limited to a single interaction modality with a particular interaction device 160. For example, keyboards, screens, display surfaces, and speech synthesizers, are all examples of physical interaction resources 160 that are attached to some computing device in the environment. Each interaction resource 150 is associated with one of these interaction devices 160. In the context of the vehicle environment as shown in FIG. 4, an input interaction resource 150 can include a channel from a touch screen button, a microphone, a button on the steering wheel, or any of a variety of input devices available in a vehicle environment. In the context of the vehicle as also shown in FIG. 4, output interaction resources 150 can include a channel to a display surface like a heads-up display (HUD), a speech or audio resource like a speaker, or any of a variety of output devices available in a vehicle environment. These interaction resources 150 are associated with the devices 160 in the environment and together they form an interaction cluster or interaction group. For a vehicle environment, an interaction cluster can include a HUD, the extended instrument cluster, and a Head-Unit, among other interaction devices available in the vehicle environment.

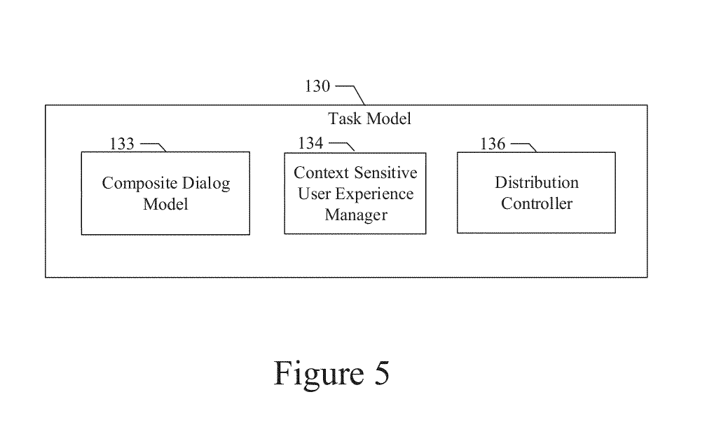

The task model 130 defines more than one equivalent way of using various interaction resources 150 on various interaction devices 160 that may be part of the interaction cluster. Further, as shown in FIG. 5, the task model 130 defines a composite dialog model 133 as a state transition network that describes the transitions that are possible between the various user interface states. The task model 130 performs task orchestration and manages the context and state transitions by dynamically building a state transition network of the interaction experience, as if the multiple integrated apps or services were a single application, although the interaction experience can be composed of many apps or services. The task model 130 provides simultaneous expression to tasks that may be fulfilled from multiple apps or services. The task model 130 can show notifications from multiple apps without switching the experience completely.

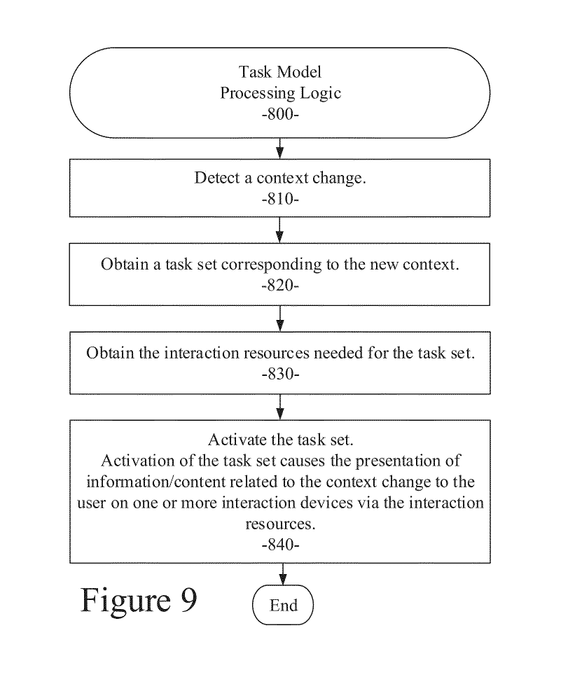

Although transitions are usually invoked by a change in context 120 or a notification request, the current context 120 is also an actor that can request a transition by virtue of a user action. The interaction resources 150 assigned by the task model 130 can use various concrete interaction resources based on the capabilities and characteristics of the interaction devices 160 that may be available in the vehicle, but the various concrete interaction resources can also be designed more generically, for any interaction cluster that might be available in a given environment. In summary, the task model 130 separates the abstraction and presentation functions of a task 140 so that the task can be realized using the available resources 160. FIG. 9 illustrates the processing 800 performed by the task model 130 in an example embodiment.

Referring again to FIGS. 1 and 5, once the task model 130 detects a context 120 change (by virtue of an asserted or requested application intent), the context sensitive user experience manager 134, shown in FIG. 5, composes the context change into the active set of tasks 140 that are temporally relevant or required to respond to the context change. The tasks 140, assigned by the task model 130 for responding to the context change, include associated abstract interaction objects and associated concrete interaction objects. There might be existing tasks that were presented to the user before the context change took place. The context sensitive user experience manager 134 determines the overall or composite dialog for the multiple simultaneous tasks that need to be presented to the user in the new context. This determination might mean replacing some existing concrete interaction objects, rearranging them, etc. The context sensitive user experience manager 134 consults a distribution controller 136 to get a recommendation on how best to re-distribute and present the concrete interaction objects using the available interaction resources 150 across the interactive cluster, such that the distribution controller 136 provides a smooth transition and a consistent experience, minimizing workload and factoring in personal relevance information, criticality or priorities, and the time sensitivity of the tasks. The distribution controller 136 makes sure that the cognitive burden of making a transition is minimized while supporting the contextual tasks and goals of the user, and the overall experience remains complete and continuous.

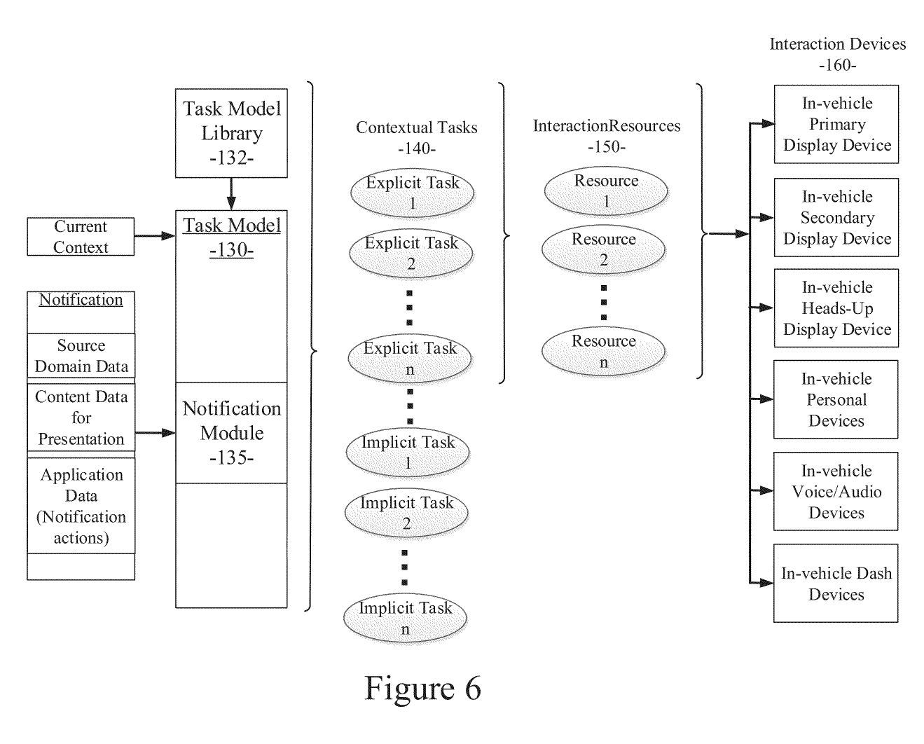

The framework 100 of an example embodiment is inclusive and can interoperate with ontologically diverse applications and services. In support of this capability as shown in FIG. 6, a notification module 135 is provided to enable any application, service, data provider, or user to present contextually relevant information in a notification. The notification module 135 of the framework 100 expects that an application intent contains: 1) domain data of the application publishing, requesting or asserting an intent (e.g., media, navigation, etc.); 2) the content data to be presented; and 3) the associated application data (e.g., actions that are available and the methods or application programming interfaces—APIs to be used to fulfill those capabilities). As an example, for an application intent such as a notification from a navigation service: a) domain data will include the spatial and temporal concepts, namely, position, location, movement and time, (b) content data will include the navigation specific content, and (c) application data will consist of the user actions and associated APIs/callbacks provided.

In summary, the framework 100 of an example embodiment considers an application intent such as an event, a published capability, or a notification as an abstract signal, a message that has a well-defined structure that includes information specifying the intent's domain, content and associated actions. The task model 130 transforms the intent abstraction into a task set that needs to be performed, in a given context, within a given set of constraints, such as a constraint corresponding to the available interaction devices 160 and their interaction and presentation resources 150. Each context sensitive task 140 can be presented using an abstract interaction object (independent of the interaction device 160) that captures the task's interaction modalities. The abstract interaction object is associated with concrete interaction objects using various input and output interaction resources 150 with various interaction devices 160 that may be associated with an available interaction cluster. Thus, like other context changes, notifications are also decomposed into tasks 140 that are enabled to respond to the notification. Thus, the task model 130 operations of mapping and planning the tasks and realizing the tasks using interaction resources is the same for notifications as with any other context change.

In the context of applications and services for a connected vehicle environment, the user experience refers to the users' affective experience of (and involvement in) the human-machine interactions that are presented through in-vehicle presentation surfaces, such as a heads-up display (HUD), extended instrument cluster, audio subsystem, and the like, and controlled through in-vehicle input resources, such as voice, gestures, buttons, touch or wheel joystick, and the like.

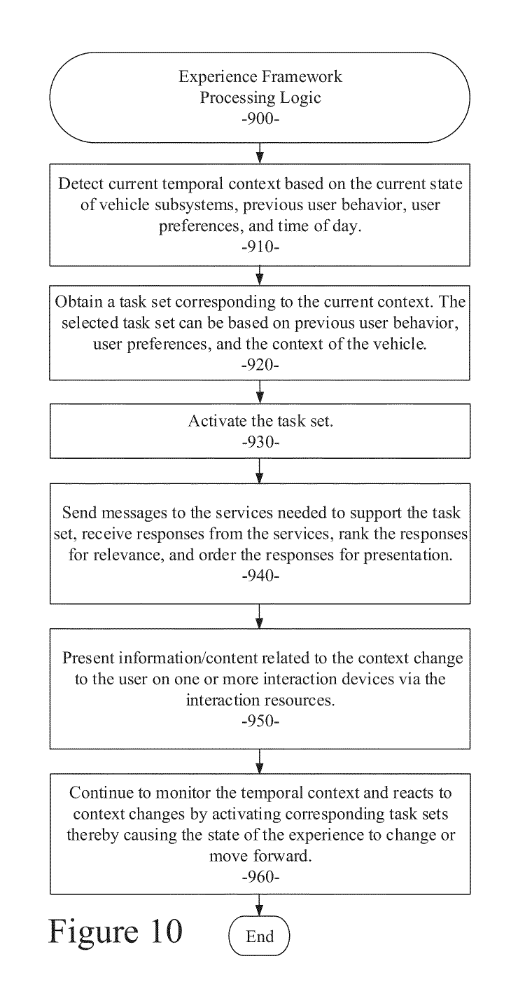

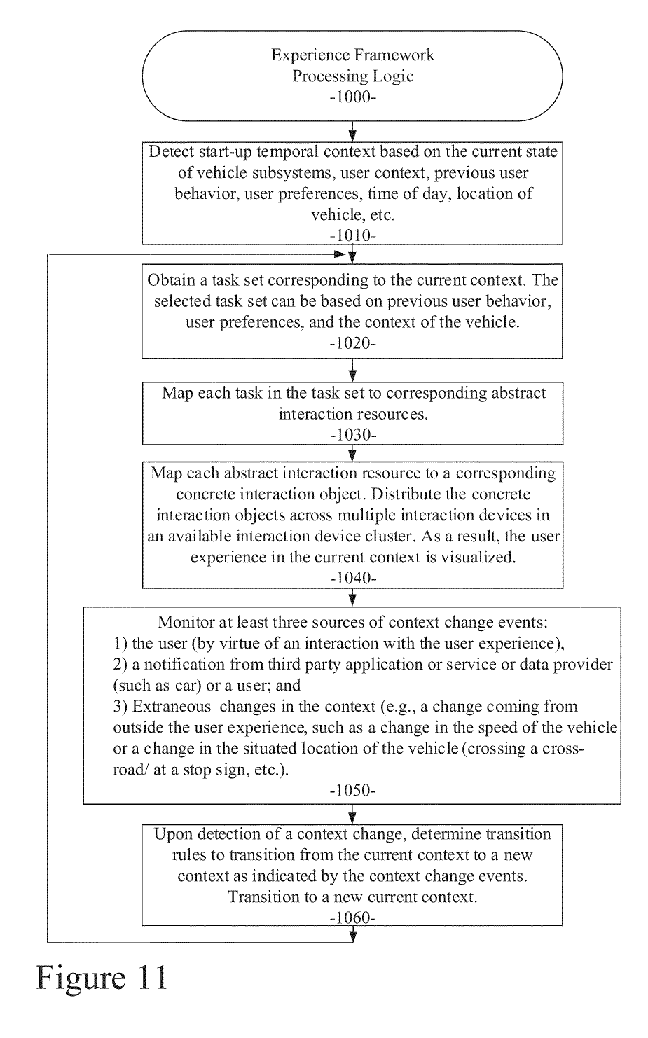

FIGS. 10 and 11 illustrate the processing performed by the experience framework 100 in an example embodiment. As shown in FIGS. 10 and 11, when the experience framework 100 of an example embodiment is instantiated, the framework 100 launches an experience based on the last known context of the vehicle. As part of launching the experience, the framework 100 performs a series of operations, including: 1) detecting the current temporal context 120; 2) assigning the applicable task set from the contextual tasks 140, the task assignment being based on the current context 120, the previous usage behavior, user preferences, etc.; 3) activating the task set; 4) sending messages to the services the framework 100 needs to perform the tasks; 5) receiving the results; 6) ranking the results for relevance and ordering the results for presentation; and 7) dispatching the interaction resources 150 to present the state of the current context to the user by use of a concrete expression (e.g., concrete interaction objects) corresponding to the interaction resources 150. Once the initial start state of the environment context is rendered, the framework 100 continuously senses the temporal context 120, interprets the context change as described above, determines if something new needs to be presented in response to the context change, determines when, how, and where the information or content needs to be presented, and then transfers the presentation into the user experience using a concrete user interface expression thereby causing the state of the experience to change or move forward.

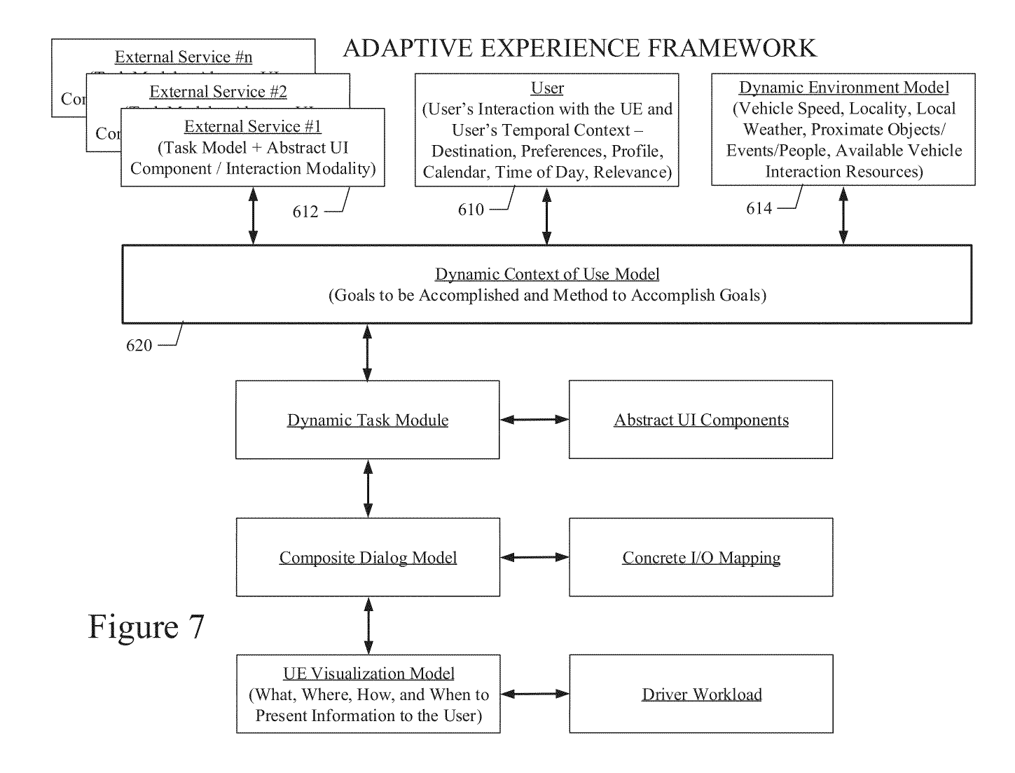

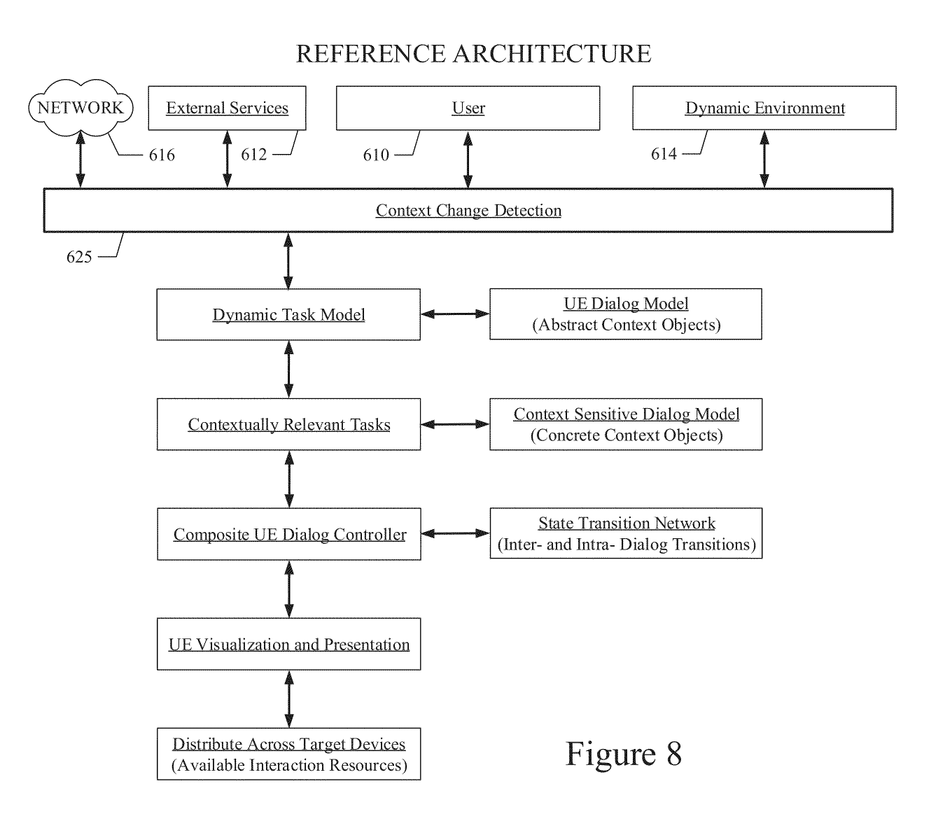

Subsequent to the rendering of the initial start state of the environment context by framework 100, user interactions can take place and the state of the experience can be changed by at least three actors: the user; the set of background applications or other external services, data sources and cloud services; and other changes in the temporal context of the dynamic environment. These actors influencing the state of the experience are shown in FIGS. 7 and 8 and described below.

The first actor, the user 610 shown in FIGS. 7 and 8, can interact with the concrete user interface expressions to control or request the actions/methods/services/metadata associated with the expressed elements. The available actions are semantically tied to each expressed element and the user experience is aware of them and provides user handles/mechanisms to control or select them. The framework 100 handles any selection or control assertion by the user, updates the presentation, and sends appropriate request and state change messages to the applicable services as described above.

The second actor, as shown in FIGS. 7 and 8, is any background application, or other external service, data service, or cloud service that wants to present some information to the user, either because the user requested the information through the presentation interaction or because the external service is publishing an event or a message to which the user or the framework 100 has subscribed. In an example embodiment, this is implemented using the intents framework, as described herein, which enables a participating application or service to advertise intents and enables users (or user data processing systems) to subscribe to these advertised intents. At run-time, the application or the service publishes these intents and they get routed for expression in the integrated experience framework, thereby making the contextually relevant vertical slice of the application or service available to the user system in a manner that preserves the application's or service's utility, usability and desirability in that environment. This is done by expressing the task(s) or task sets associated with the intent using the task model described above, visualizing the task sets using the available interaction resources, and orchestrating the execution of the task sets through their transitions. Thus, an incoming intent from an application or a service extends the scope and operability of the framework 100 as the external service can cause the invocation of a new task set containing abstract user experience components through the task model 130. Again, the framework 100 notifies any applicable services with an update to modify the dialog model.

The third actor, as shown in FIGS. 7 and 8, which is able to change the state of the user experience, includes any other changes in the temporal context of the dynamic environment. For example, any changes in the vehicle speed, locality, local weather, proximate objects/events/people, available vehicle interaction resources, or the like can trigger a corresponding activation of a task set and a corresponding presentation of information or content to the user via the interaction resources and interaction devices as described above.

As described herein, the experience framework 100 of an example embodiment is a system and method that, in real-time, makes sense of this multi-sourced data, temporal context and signals from a user's diverse set of applications, services and devices, to determine what to present, where to present it and how to present it such that the presentation provides a seamless, contextually relevant experience that optimizes driver workload and minimizes driver distraction.

Further, the experience framework 100 of an example embodiment is not modal or limited to a particular application or service that wants to manifest itself in the vehicle. Instead, the experience framework 100 is multi-modal and inclusive of any applications and services explicitly selected by the user or configured to be active and available while in-vehicle. In an example embodiment, this is done by enabling the applications and services to advertise and publish application intents in a specified format and the user (or user data processing system) to subscribe to some or all of the advertised intents. At run-time, the application or service publishes all the advertised intents; but, only the user subscribed intents are routed to the framework. It is a framework that enables mediated interaction and orchestration between multiple applications, data, and events to present an integrated, seamlessly connected, and contextually relevant experience with coordinated transitions and interactions in an ambient intelligent environment. The experience framework 100 of an example embodiment performs task orchestration and manages the context and state transitions, as if the multiple integrated apps or services were a single application. The experience framework 100 can show notifications from multiple apps without switching the experience completely. As a result, experience framework 100 addresses distracted driving, because the framework 100 mediates all context changes and presents corresponding user interface content changes in a manner that does not result in abrupt visual and interaction context switching, which can distract a driver.

The experience framework 100 of an example embodiment enables applications and services to be brought into the vehicle without the developer or the applications or the service provider needing to be aware of the temporal context of the vehicle (e.g., the vehicle speed, location, traffic, weather, etc.) or the state of the integrated experience. The experience framework 100 assures that these applications and services brought into the vehicle get processed and expressed in a manner that is relevant and vehicle appropriate.

In a moving vehicle, consuming applications and services on the mobile device and/or the in-vehicle IVI platform results in distracted driving because it increases the manual, visual, and cognitive workload of the driver. Apart from consuming an application or service like navigation or music, drivers want to stay connected with people, places, and things in their digital world. Users consume notifications from these mobile applications and cloud services, and these notifications further increase driver workload as drivers switch contexts on receipt of the notifications. The problem gets compounded as changes in the temporal context caused by the dynamic environment (e.g., changes in vehicle speed, location, local traffic, and/or weather conditions, etc.) also increase the driver workload, narrowing the safety window.

Today, there are two broad approaches to addressing distracted driving. One approach is to limit the use of an application or service by de-featuring or locking the application or service when the vehicle is in motion. Another approach is designing applications that specifically address distracted driving. The first approach does not seem to work in the general public. For example, when an in-vehicle app gets de-featured on an in-vehicle IVI, drivers tend to use their mobile device, which does not lock or de-feature the app when the vehicle is moving. The second approach is dependent on the application developer and the use cases the app developer covers to address distracted driving. However, even if a particular application is well designed from a distracted driving point of view, the app cannot always be aware of the context of the vehicle. Further, applications tend to be different in terms of the information or content they want to present, their interaction model, their semantics, and the fact that different people are developing them; their experience will very likely be different and difficult to reconcile with resources available in the environment. Furthermore, as the user uses the apps, switches from one application to another, or consumes a notification from an app or service, the context changes increase the driver's visual, manual and cognitive workload. As a result, there is no good solution to addressing distracted driving in conventional systems.

The experience framework 100 described herein addresses the problem of distracted driving by taking a more holistic view of the problem. The experience framework 100 operates at a broad level that enables the unification of in-vehicle systems, mobile devices, and cloud-based resources. The experience framework 100 enables applications and services to advertise and publish intents that can be consumed by the user (or the user data processing system) in their vehicle in a manner that is vehicle-appropriate. As a result, experience framework 100 can monitor and control a unified in-vehicle experience as a whole as opposed to dealing with individual systems on a per application basis. The experience framework 100 as described herein interoperates with multiple data sources, applications and services, performing processing operations to determine what, when, where and how to present information and content, such that the framework 100 can address distracted driving at the overall in-vehicle experience level. This means that apps and/or services do not necessarily run directly in the vehicle or on a user's mobile device. Rather, the apps and/or services get incarnated and presented through a uniform, consistent user experience that homogenizes the apps and/or services as if one vehicle-centric application was providing all services. The framework 100 minimizes the dynamic driver workload based on a vehicle's situational awareness, scores the relevance of what is requested to be presented based on the user's and vehicle's temporal context, and leverages a few vehicle-safe patterns to map and present the diversity of application, data, and content requests. Because the framework 100 can dynamically and seamlessly integrate the user interfaces of multiple devices, services, and/or apps into the environment and into the user experience, the framework 100 eliminates the additional visual and cognitive workload of the driver that occurs if the driver must adapt to the significant differences in user interaction controls, placement, interaction modalities, and memory patterns of widely variant user interfaces from different non-integrated devices, services, and/or apps. Additionally, the framework 100 is inclusive and can be applied across ontologically diverse applications and services.

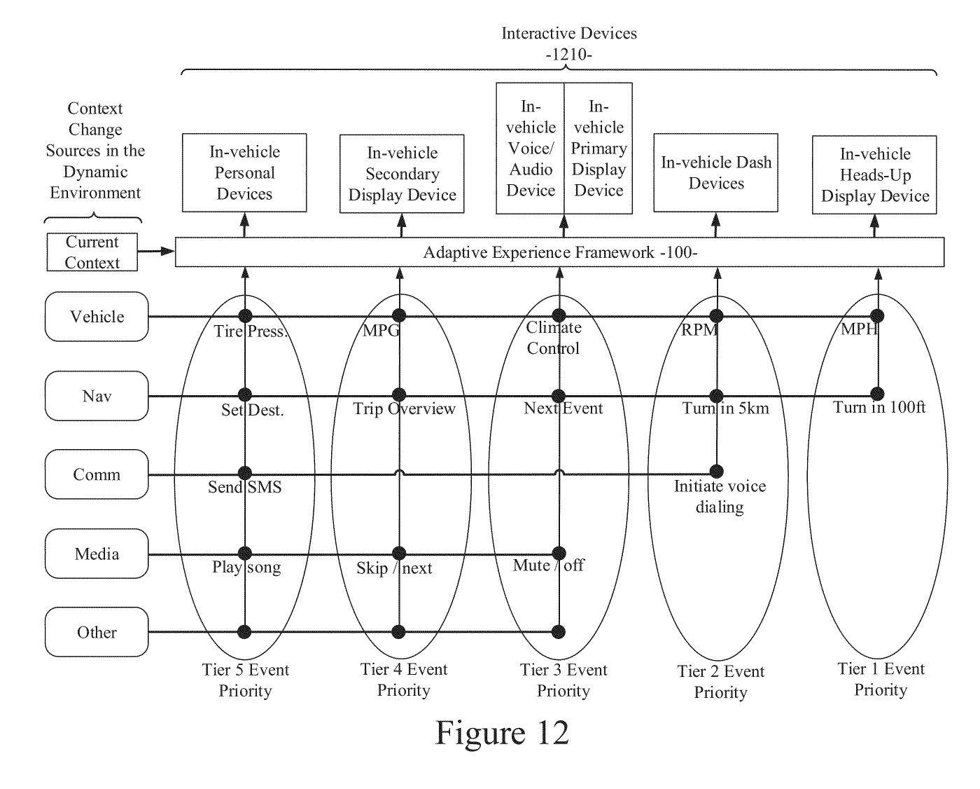

Referring now to FIG. 12, an example of the framework 100 in a vehicle environment is illustrated. As shown, the vehicle environment can source a variety of context change events, application intents, or notifications (e.g., events from a variety of vehicle subsystems, such as vehicle sensors, a navigation subsystem, a communication subsystem, a media subsystem, and the like. Each context change event, notification, or application intent can have a particular priority or level of criticality in the dynamic environment. As a result of these context changes, the framework 100 can assign a corresponding task set, as described above, to cause information or content presentations on one or more of the interactive devices 1210 in the vehicle environment. Because the framework 100 is holistically aware of the vehicle environment, the framework 100 can present the information or content to the user in a context-sensitive and priority-sensitive manner that is most likely to convey necessary information to the driver in the least distracting manner possible. For example, a message to the driver from the navigation subsystem regarding a high priority imminent turn can be shifted to the HUD, even though the message might be usually displayed on the primary display device on the dashboard. Similarly, while the high priority navigation message is being presented, less important messages in the particular context, such as those from the media or communication subsystems, can be suppressed or delayed until the higher priority presentations are completed. This is just one representative example of the dynamic nature of the adaptive experience framework 100 as described herein.

The holistic nature of the framework 100 makes the framework applicable beyond delivering only vehicle-centric or vehicle-safe experiences. The framework 100 can also be used to provide contextually relevant and consistent experiences for connected devices, in general. This is because applications on connected devices, such as mobile devices or tablet devices, are consumed exclusively where the active application has an absolute or near-complete control of the device's presentation and interaction resources. Other applications can continue to run in the background (e.g., playing music); but, anytime the user wants to interact with them, that background application must switch to the foreground and in turn, take control of the presentation and interaction resources. This process results in a fragmented or siloed user experience, because the user's context completely switches from the previous state to the new state. As long as the user remains within the active application's context, other applications and services remain opaque, distant, and generally inaccessible to the user. While background applications and services can send event notifications (such as a SMS notification or a Facebook message) that get overlaid on top of the active application, the user cannot consume and interact with the event notification until the active application performs a context switch to change from the current application to the notifying application.

The experience framework 100 as described herein provides a context fabric that stitches application intents, transitions, notifications, events, and state changes together to deliver consistent experiences that are homogeneous, composed using a set of contextual tasks and interaction resources that address distracted driving and driver workload. In the context of the vehicle environment as described herein, the experience framework 100 manifests itself as the foreground or active application, and all other applications, cloud services, or data sources run in the background as if they were services. In other words, the experience framework 100 treats all applications, cloud services, and data providers as services and interacts with them through service interfaces, exchanging application intents and the associated data and messages via APIs. The experience framework 100 essentially implements a dynamic model that represents context changes and provides an intent-task model to react to these context changes in an appropriate way, which in a vehicle environment means addressing driver distraction as well.

### In-Vehicle Experience Framework

In various embodiments described herein, an overall goal of the in-vehicle experience framework is to reduce the amount of driver effort required, reduce the driver's cognitive, manual, and visual workload, to stay network-connected, to be able to push and pull information from a plurality of applications and services, and to enable the driver to safely act on the information in a moving vehicle. The reduction of driver effort includes reducing the activities required to process the push and pull of contextually relevant information from multiple applications, and reducing the driver effort involved in interacting with (e.g., taking action on) the selected information. In addition, the in-vehicle experience framework of an example embodiment provides active monitoring of the user's and vehicle's context and situation to provide the appropriate information from in-vehicle data sources at the appropriate time at the appropriate place in an appropriate form, such that the information presented is contextually relevant, safely consumable (e.g., glanceable/audible), and easily actionable using the primary inputs from the vehicle.

In the in-vehicle experience framework of an example embodiment, a summary of the key requirements addressed are as follows:

1. Inclusive—Any endpoint should be able to push information to the driver and the driver should be able to pull information from any endpoint. The endpoints can include any vehicle-connectable data source, such as an app on the user's smartphone (mobile device), a network-connectable site, a third party service, an object of physical infrastructure (such as a traffic light, a toll bridge, a gas pump, a traffic cone, a street sensor, a vehicle, or the like), and a subsystem of the user's vehicle itself. A related requirement is that this bi-directional push and pull must happen in a manner that is vehicle and driver safe.

2. Relevant—To minimize distraction and driver workload, the amount and variety of information presented to the driver should be minimized. This means only minimal or contextually relevant information or the most appropriate information should be presented to the driver. A related requirement is that a user's/driver's experience context should not change on a per information basis—it should be continuous and without modalities.

3. Vehicle-safe Interactions—Any information that is determined to be relevant should be presented in the appropriate form and in the appropriate place (e.g., on the appropriate I/O surface or device in the vehicle). Further, the appropriate information should be presented to the driver at the appropriate time when a vehicle-safe interaction is possible, such as when the cumulative workload from this information presentation interaction and from other existing activities (e.g., driving plus talking) is within safe limits. A related requirement is to minimize the interaction patterns and keep them consistent across the variety of information types regardless of the app or service from which they come.

In summary, the solution should enable a driver to get their jobs safely done, the jobs for which they use the smartphone or other network-connected devices in a moving vehicle, without significantly increasing their cognitive, manual, and visual workload. Designing for safety first, an example embodiment of the in-vehicle experience framework that addresses these three requirements safely is described in more detail below.

### 1. Inclusive Information Push and Pull

The framework of an example embodiment described herein provides an API that enables any endpoint (e.g., an app, a third party service, etc.) to push and pull information to the vehicle. This openness is only a necessary condition but not sufficient on safety grounds; because, having multiple endpoints that can push information to the vehicle allows the endpoints to choose to push any information, in any form, at any time, for display to any surface in the vehicle. Likewise, providing multiple endpoints from which information could be pulled could mean exposing the driver to deal with multiple UIs. This uncontrolled push and pull of information to the vehicle can produce unsafe conditions for the driver.

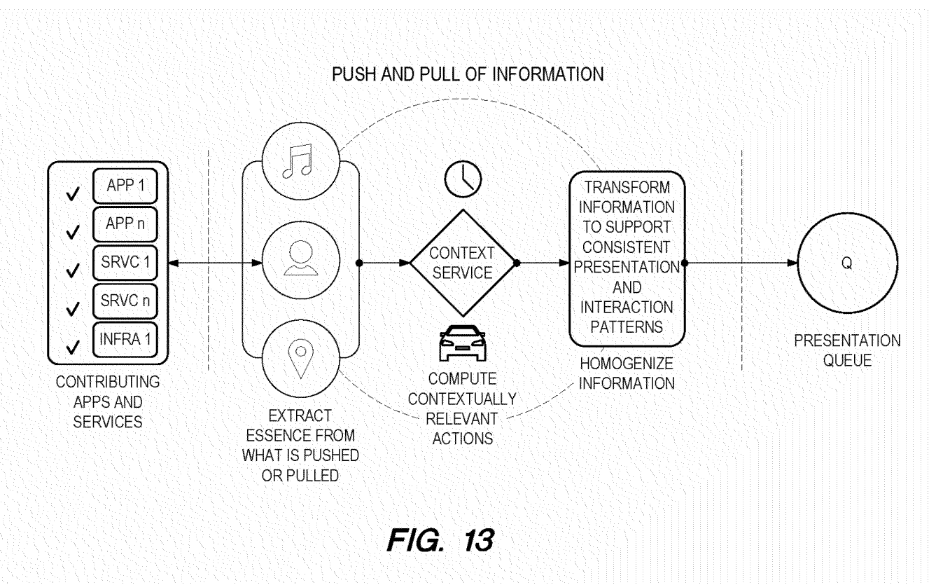

Referring now to FIG. 13, framework of an example embodiment described herein solves this problem by creating an abstract presentation layer to homogenize any information that needs to be pushed to the vehicle or pulled (requested) by the vehicle or driver. This means that regardless of the source of information (e.g., app, service, infrastructure, etc.), or the type of information (e.g., navigation, media, communication related information, etc.), the framework of an example embodiment extracts the essence from the information in terms of what the information is about and what actions can be taken on the information. If there are multiple actions that can be taken, the framework of an example embodiment prioritizes and selects the primary action or the most likely action that makes sense based on the information type and the context of the driver and vehicle. The result is that all information gets homogenized, whether it is pushed to the vehicle or pulled from the vehicle. The bonus effect of this homogenization is that all information gets presented as part of one continuous user experience regardless of the information source (e.g., app, service, infrastructure, etc.) or information type. This eliminates any modalities (e.g., switching between apps or views) and the driver no longer has to deal with individual UIs to push or pull information. FIG. 13 illustrates this push and pull of information in an example embodiment.

The example embodiment described herein implements the push path from apps and services via integration with the on-device notifications center to receive all in-bound notifications from the driver's apps and services. The push of information from apps and services can be triggered via proximity/near-field communications with devices as well as infrastructure. All pushed information can be semanticized based on its source and that information source is used to extract the essence of the information, determine likely actions based on the essence of the information, and transform or normalize the information for homogeneous consumption.

The information pull path is implemented by federating (integrating with) cloud services for maps, turn-by-turn route guidance, traffic, media (e.g., streaming music, news, Internet radio,), point of interest (POI) locations, search and communication (e.g., talk, messaging, etc.) services, and the like. This allows either the user or the in-vehicle experience to pull information using APIs. This programmatically pulled information can be semantically parsed to extract the information essence, determine likely actions based on the essence of the information, and transform or normalize the information for homogeneous consumption.

### 2. Contextual Relevancy of Information

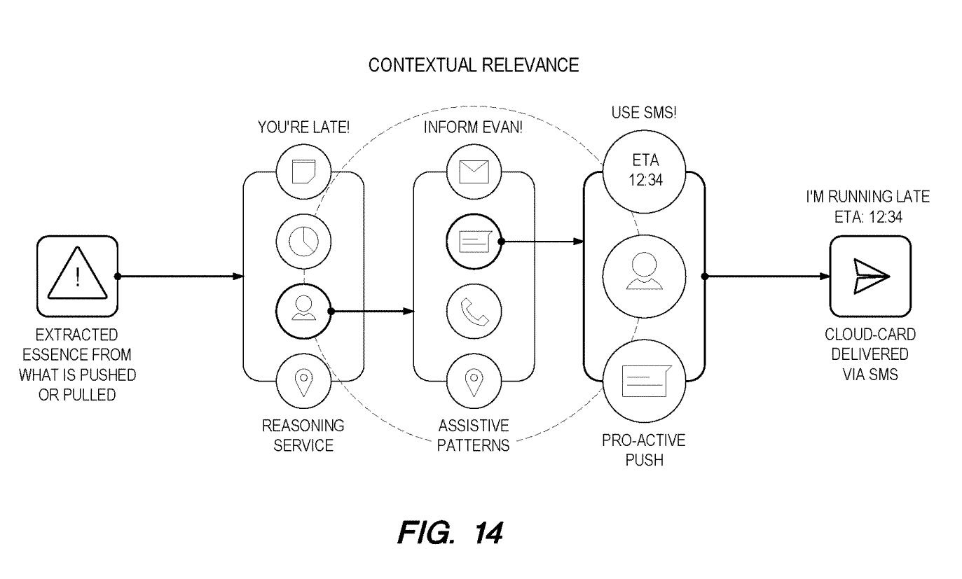

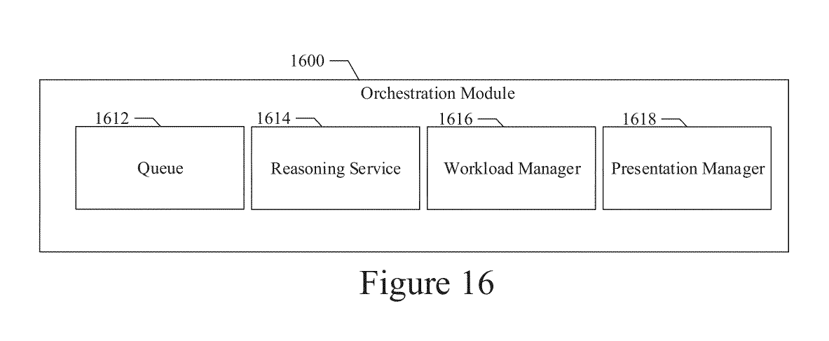

Referring now to FIG. 14, a diagram illustrates the contextual relevancy processing in an example embodiment. In the example embodiment, all information that is pushed from apps and services can be filtered, scoped, and scored for relevance based on the driver's temporal context, geographical context, system state, and activity context (denoted generally as the driver context or vehicle context). The example embodiment described herein provides an intelligent agent, a Reasoning Service 1614 described in more detail below in connection with FIG. 16, that uses the driver context or vehicle context to determine (e.g., filter, rank, scope, etc.) the information that is contextually relevant for the driver at a particular moment. Armed with situational and contextual awareness, Reasoning Service 1614 can determine and prioritize the information that needs to be presented to the driver and differentiate from the information that should be suppressed (or delayed). Reasoning Service 1614 can also determine and prioritize how the information needs to be presented (e.g., the form it takes), where the information needs to be presented (e.g., which audio video surface of the vehicle would be most appropriate for that information), and finally when is the appropriate opportunity window to present that information and for how long to present it.

Likewise, when the user/driver makes an operational request to the system of an example embodiment to perform a task or pull information, such as, “navigate to Stanford University” or “play the Beatles” or “find Starbucks”, the results of the request are filtered, scoped, and ranked based on their relevancy to the current driver or vehicle context. For example, the Reasoning Service 1614, in some situations or contexts, might rank the not-the-closest Starbucks over the closest Starbucks based on the user's history. In another example, the Reasoning Service 1614 might rank a gas station that is along the route of travel higher than the closest gas station. It will be apparent to those of ordinary skill in the art in view of the disclosure herein that many other context relevancy determinations can be performed by a particular embodiment.

Further, the situational or contextual awareness enables the Reasoning Service 1614 to proactively push information to the driver based on assistive patterns that are useful to the driver and will likely reduce the driver's anxiety, distraction, and thus workload. For example, consider a scenario wherein the driver has a calendar appointment to meet Jim at the Four Seasons Hotel in Palo Alto at 12:30 pm. This sample appointment or event can be retained in a user/driver appointment or calendar application using conventional techniques. When the driver gets into the vehicle at, say 12 noon, the Reasoning Service 1614 can infer that the driver is likely headed to the Four Seasons Hotel, based on the proximity of the appointment/event time to the current time. Based on this inference, the Reasoning Service 1614 can cause the Four Seasons Hotel to be presented to the driver as the likely destination with an option to automatically invoke a navigation function as an action. This operation of the Reasoning Service 1614 saves the driver from manually entering the destination into the vehicle's navigation system or an app. Another example where the Reasoning Service 1614 can use assistive patterns to push information is when the Reasoning Service 1614 determines that the driver is running late for a meeting based on the time to destination in comparison with the current time and the appointment time. In this case, the Reasoning Service 1614 can proactively offer the driver a suggestion that the Reasoning Service 1614 can cause a message to be sent to a pre-configured location/person to inform the party being met that the driver is running late. The Reasoning Service 1614 can also cause the estimated time of arrival (ETA) to be conveyed to the party being met. It will be apparent to those of ordinary skill in the art in view of the disclosure herein that many other context relevancy determinations and assistive patterns can be used to push information to a user/driver in a particular embodiment.

### 3. Vehicle-Safe Interactions

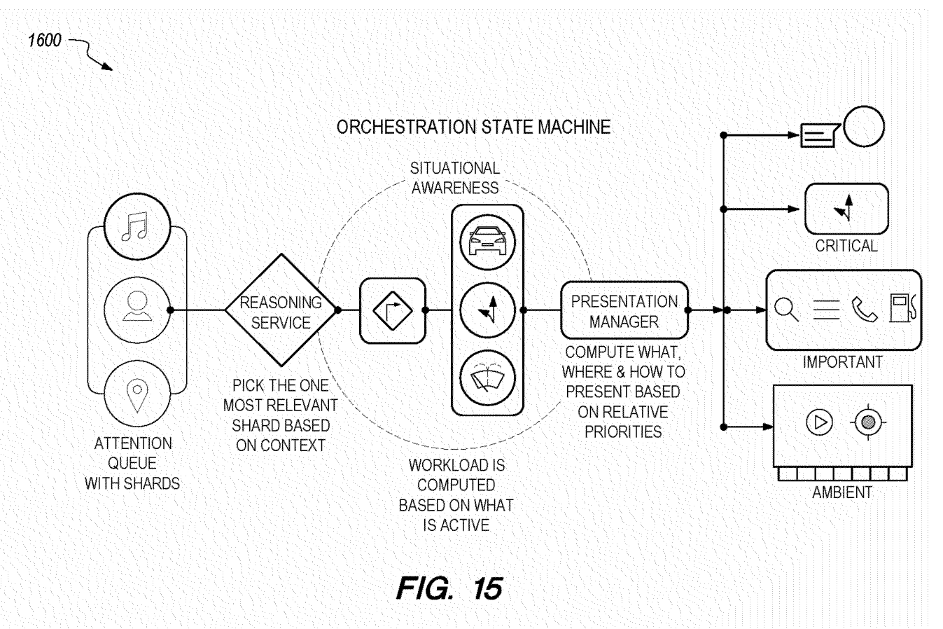

Referring now to FIG. 15, the diagram illustrates the structure of the orchestration state machine or module 1600 of an example embodiment. In the example embodiment, information or content from apps and services can be aggregated and presented to a driver by the orchestration module 1600 while maintaining a safe driving experience. The intelligent experience framework as implemented by the orchestration module 1600 of an example embodiment orchestrates on-screen events in the vehicle to ensure safety. As used herein, the term “on-screen” denotes all I/O surfaces or rendering devices in the vehicle. The orchestration module 1600 of an example embodiment extracts the essence from the information that is determined relevant and transforms the extracted information into atomic units (denoted herein as information shards or just shards) that can be homogenized into one continuous experience. This is done by determining the likely actions (verbs) that could be taken on the type of information (noun) being processed.

The actions associated with the information shards processed by the orchestration module 1600 are enabled using the primary and available HMI (human-machine interface) inputs from the vehicle (e.g., up, down, left, right, select, keypad, and speech/microphone inputs). These HMI inputs are available in most conventional vehicles. However, before this homogenized information is presented for user interaction, the orchestration module 1600 determines the most appropriate form for the information, the most appropriate surface for presenting or rendering the information, and the most appropriate time to present the information. In the example embodiment, this process is called Orchestration and it minimizes the dynamic workload on a driver by prioritizing, pacing, and transforming information into forms that are easier and safer for consumption and interaction in a moving vehicle.

FIG. 16 illustrates the structure of the orchestration module 1600 in an example embodiment. Referring to FIG. 16, the orchestration module 1600, the agent responsible for orchestration in the example embodiment, uses four core components: 1) the Queue 1612, 2) the Reasoning Service 1614, 3) the Workload Manager 1616, and 4) the Presentation Manager 1618. The Queue 1612 represents the collection of contextually relevant shards or portions of information. The Reasoning Service 1614 is situationally and contextually aware of the driver and vehicle context and determines the most appropriate assistive patterns that make sense in the current context in which the driver and vehicle are operating. The Reasoning Service 1614 selects the one or more most relevant shards of information that make sense in the driver's current context. The Workload Manager 1616 determines the active workload of the user/driver and tracks the active workload over time and events to determine the opportunity windows or preferred manner to present the selected shard(s) of information to the driver. Finally, the Presentation Manager 1618 determines, how, where, and when to present the selected shard(s) of information to the driver based on the selected shards' priorities relative to the other active shards.

For example, consider a sample scenario wherein the user/driver makes a request to play a particular music selection. The media stream corresponding to the music selection is pulled and a shard is created and added to the Queue 1612. The Reasoning Service 1614 can determine that this shard is the most relevant shard, given the user request. The Reasoning Service 1614 can mark the shard for active presentation. The Workload Manager 1616 can determine the workload activities in which the driver is currently involved in the current context. In this particular example, the Workload Manager 1616 can determine that the driver in the current context is involved in two activities (e.g., driving under normal conditions and listening to music). The Workload Manager 1616 can compute the total workload for the driver in the current context based on the activities in which the driver is currently involved. The Workload Manager 1616 can then compare the computed total workload of the driver in the current context to a pre-defined workload threshold (e.g., a maximum workload threshold value). The Workload Manager 1616 can then determine if the computed total workload of the driver in the current context is below (e.g., within) a safe threshold. If the current driver workload is within the safe threshold, the Workload Manager 1616 can send the selected media stream for audible presentation to the driver via the audio surfaces (e.g., rendering devices) of the vehicle or a mobile device. The Workload Manager 1616 can also send an information shard with the related album art, the title/track name, and music state to a rendering device on the center stack of the vehicle.

Now, given the example scenario described above, consider an alternative example in which the driver receives an incoming phone call. This call event gets added to the Queue 1612. The Reasoning Service 1614 can determine that the call is highly relevant (e.g., based on pre-configured preference parameters or related heuristics, the identity of the calling party, the time of the call, etc.) and recommend the call for presentation to the driver. The Reasoning Service 1614 can activate the Workload Manager 1616. The Workload Manager 1616 can re-compute the driver workload based on the new call event. The Workload Manager 1616 can determine that the cumulative workload of driving, plus listening to music in the background, plus talking on the phone is still within a pre-defined workload threshold. However, the Workload Manager 1616 can prioritize the received call with a priority level greater than the priority level of the music selection being played. For example, the Workload Manager 1616 can prioritize the received call with a priority of 80% and the music selection with a priority of 20%. As a result, the Workload Manager 1616 can cause the Presentation Manager 1618 to push the rendering of the music selection to the rear speakers of the vehicle at a 20% audible volume level and audibly present the call to the driver at an 80% audible volume level on the front speakers of the vehicle. It will be apparent to those of ordinary skill in the art in view of the disclosure herein that a variety of alternative priorities and related actions can be implemented in various alternative embodiments.

Now, given the example scenario described above, consider an alternative example in which an SMS text message arrives on a driver device or vehicle device. This text message event gets added to the Queue 1612. The Reasoning Service 1614 can determine that the received text message is relevant and recommend the text message for presentation to the driver. The Reasoning Service 1614 can activate the Workload Manager 1616. The Workload Manager 1616 can re-compute the driver workload based on the new text message event. The Workload Manager 1616 can determine that the cumulative workload of driving, plus listening to music in the background, plus talking on the phone, plus viewing and/or interacting with the received text message will exceed the pre-defined workload threshold of the driver. As a result, the Workload Manager 1616 can keep the received text message pending and block the text message from presentation while the driver workload in the current context is unable to accommodate the presentation of the received text message. Once the call is terminated or other events occur or terminate to reduce the driver workload, the Workload Manager 1616 can approve the text message for presentation to the driver, if the pre-defined workload threshold of the driver is not exceeded.

Now, given the example scenario described above, consider an alternative example in which instead of receiving an SMS text message, a navigation system in the vehicle needs to issue a turn by turn guidance instruction to the driver while the phone call is active and the selected music track is playing in the background. The Reasoning Service 1614 can determine that the navigation instruction is highly relevant and recommend the navigation instruction for presentation to the driver. Similarly, information from another vehicle subsystem or detection of a particular vehicle state may be received and processed by the Reasoning Service 1614. The Reasoning Service 1614 can activate the Workload Manager 1616. The Workload Manager 1616 can re-compute the driver workload based on the new navigation instruction event. The Workload Manager 1616 can determine that the cumulative workload of driving, plus listening to music in the background, plus talking on the phone, plus receiving a navigation instruction is still within a pre-defined workload threshold. However, the Workload Manager 1616 can determine that the cumulative driver workload is only within the safe threshold if the navigation instruction is displayed on a vehicle heads-up display and not audibly read out while the phone call is active. In this case, the Workload Manager 1616 can direct the Presentation Manager 1618 to display the navigation instruction on the vehicle heads-up display and suppress audible presentation of the navigation instruction.

Many other examples can be used to illustrate other aspects and features of the orchestration performed by an example embodiment. For example, consider a scenario in which the orchestration module 1600 receives an incoming text message for the driver. The Reasoning Service 1614 can determine that the received text message is relevant and recommend the text message for presentation to the driver. The Reasoning Service 1614 can activate the Workload Manager 1616. The Workload Manager 1616 can re-compute the driver workload based on the new text message event. The Workload Manager 1616 can determine that the cumulative workload of the driver is within a pre-defined workload threshold as described above. However, the Workload Manager 1616 can also determine that driver workload can be diminished if the text message is transformed from a text format to an audible speech format and audibly read out to the driver. The Workload Manager 1616 can direct the Presentation Manager 1618 to perform this conversion and audible rendering of the text message to the driver. Concurrently or subsequently, the Workload Manager 1616 can direct the Presentation Manager 1618 to convert the text message metadata to a text notification, which can be displayed on the center stack of the vehicle while the audible content of the text message gets read out to the driver. The driver can reply to the text message using a voice interface and thus avoid the use of a keypad for either requesting to read the message or to reply to the message.

Now, given the example scenarios described above, consider an alternative example in which the driver is currently in a different contextual situation or environment. In this example, the vehicle windshield wipers are active, the vehicle fog lights are active, and the user is currently executing a driving maneuver (e.g., a maneuver to merge into a highway) based on actions on the accelerator, steering wheel, brakes, and/or turn indicators. The orchestration module 1600 of an example embodiment can determine these vehicle events based on information received from vehicle subsystems as described above. As described above, the Workload Manager 1616 can compute the current driver workload based on the driver's current context. In particular, the Workload Manager 1616 can determine that the cumulative driver workload of driving in rain, plus driving in fog, plus executing a driving maneuver is still within a pre-defined workload threshold. However, at the same moment, if an in-coming SMS text message arrives, the Workload Manager 1616 can determine that the current driver workload based on the current context (e.g., driving plus rain plus fog plus driving maneuver plus text message) is higher (e.g., outside) than the safe limit threshold. As a result, the Workload Manager 1616 can direct the Presentation Manager 1618 to keep the text message pending and non-rendered until the driver workload decreases to a level at which the text message can be rendered to the driver while remaining within a safe driver workload threshold. In this particular example, the driver workload may decrease after the driver has completed the driving maneuver, the rain stops, the fog lifts, or the driver stops the vehicle.

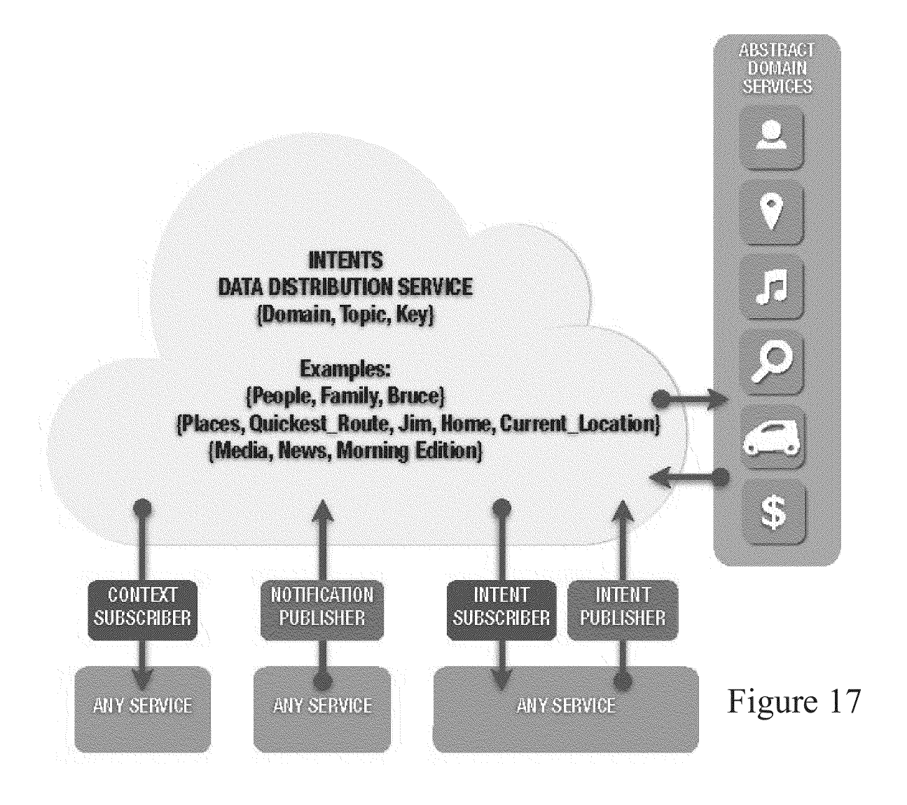

FIG. 17 illustrates the intents data distribution service in an example embodiment. In an example embodiment, user and vehicle context is shared with a host service provider, original equipment manufacturers (OEMs), and third party services via an Intents Data Distribution Service (DDS). DDS is a data-centric middleware pattern that subsumes publisher/subscriber messaging. In an example embodiment, a peer-to-peer (P2P), de-centralized network can be used for data communication between parties. This architecture de-couples publishers and subscribers and enables implementation of a distribution policy and control mechanisms. The DDS Service maintains state information, so interested end-points don't have to infer or re-construct state. End-points can operate on state directly and not on messages about state.

In an example embodiment, the Intent architecture uses a bi-directional Intent model, which uses an interface specifying three basic objects: Domain, Topic, and Key. The Intent model is independent of any application or service. The Domain object scopes and partitions the global data space, e.g., People, Places, Media, Information (Search), Telemetry and Transactions. The Topic object represents a collection of similar data objects, e.g., Playlist, Family, Transactions, etc. Multiple instances of the same Topic are allowed. All Intents are modeled as Topics. The Key object can be any set of field(s) in the Topic (e.g., LocationID; or (Artist, Album, Track)).

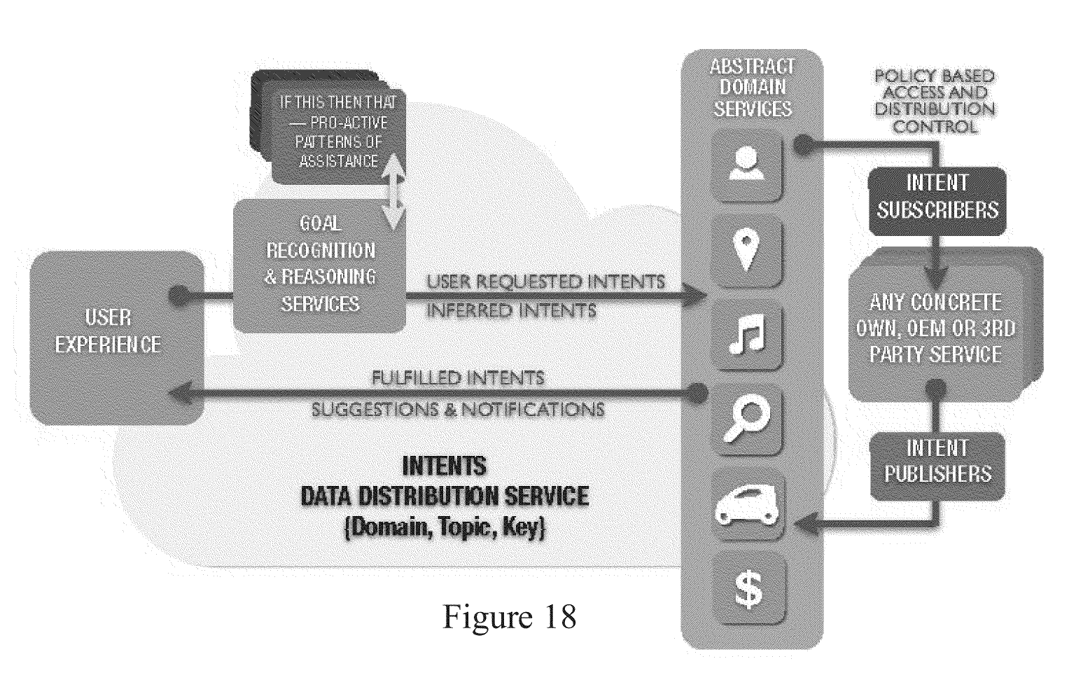

FIG. 18 illustrates the intents data distribution service in an example embodiment with detail on the user requested intents and inferred intents. In an example embodiment as shown in FIG. 18, Abstract Domain Services act as an Intents Brokers and Services Gateways. An intent is a first-class object used to request a job-to-be-done, for sharing context, or delivering results. All user requests and actions are sent as intents. All situationally-aware or pro-active patterns of assistance are also modeled as intents (e.g., inferred intents). User requests are mapped onto intents using a Goal Recognition and Reasoning Service. In a particular embodiment, the Reasoning Service uses statistical reasoning. The Reasoning Service subscribes to a user's context and exposes the context to a set of rules to generate inferred intents. The set of rules can be based on patterns of pro-active assistance. In an example embodiment, all intents (requested or inferred) are thus commonly abstracted using the Domain, Topic and Key objects and are routed to the appropriate abstract Domain Services. A Domain Service understands the Topic of the intent and breaks the Topic down into atomic intents that can be fulfilled by a subscribing service. Atomic intents are dispatched to all services that have subscribed to them for fulfillment or just to be aware of the context. The services publish fulfilled intents, which get routed back to the Abstract Domain Service.

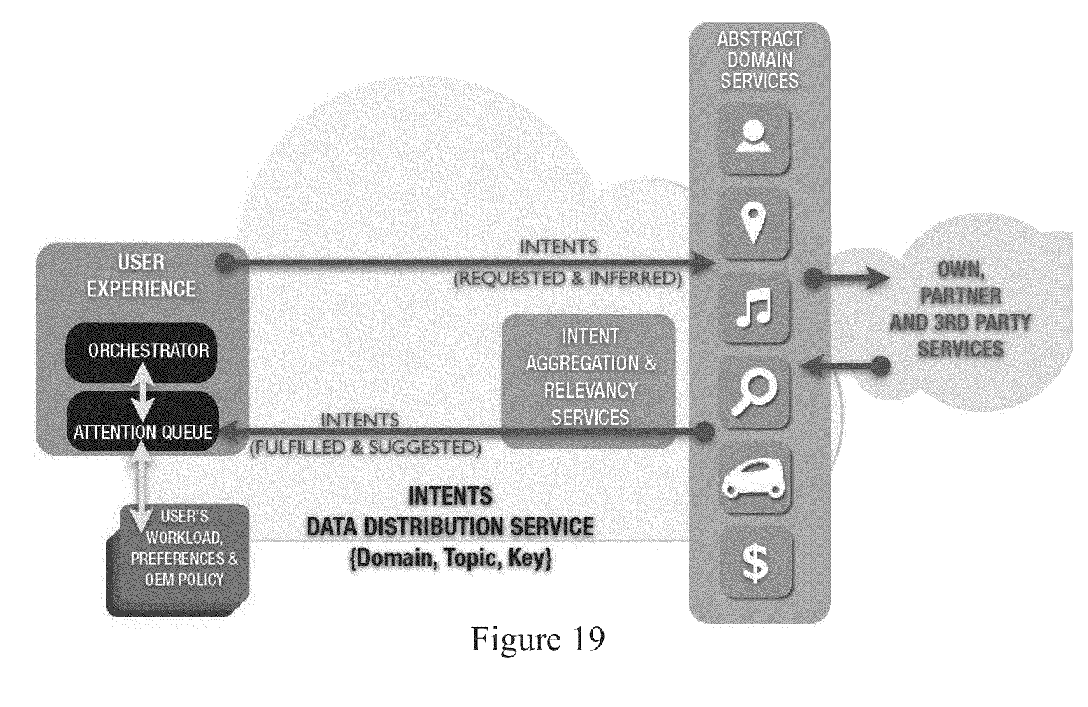

FIG. 19 illustrates the intents data distribution service in an example embodiment with detail on the fulfilled and suggested intents. In the example embodiment, the intents data distribution service can filter, rank and homogenize intents into one continuous experience. All intents (requested or inferred) are dispatched to the services that have subscribed to them. Services send back results as (published) intents. Likewise, notifications are published as intents to which the Abstract Domain Services subscribe. The received intents get aggregated, de-duped, and ordered. A Relevancy Service leverages a user's personal data corpus and a user's stated and learned preferences to filter and rank intents for relevancy. The highest-ranked intent enters the Attention Queue as a suggestion for presentation to the user. The orchestrator uses the dynamic workload, user preferences, and OEM policy to determine what data to present/suppress, how to present the data, where to present the data, and when to present the data to maximize the utility of the information for the user and minimize the distraction effect of the data presentation.

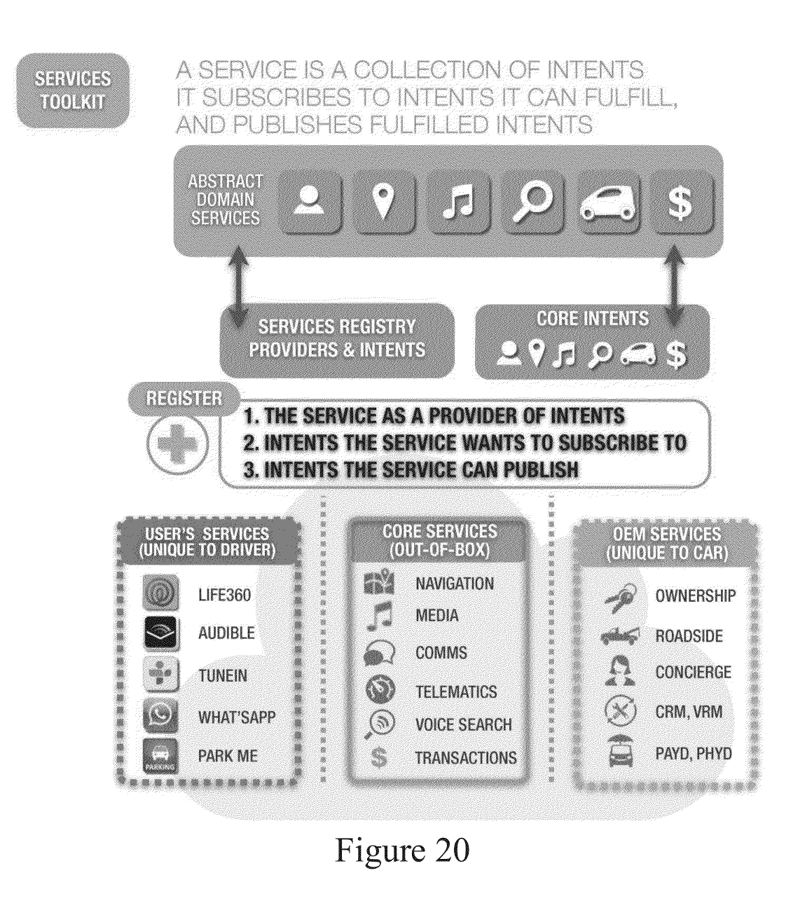

FIG. 20 illustrates the services structure of an example embodiment. A Services ToolKit enables OEMs and developers to create new services by adding intents the services can fulfill. OEMs use the Services Toolkit to keep services active and current and to create differentiated offerings. Adding a service is equivalent to defining the service in terms of the contexts to which the service relates and the capabilities provided by the service in the related context. Contexts are shared as intents (Topics) to which any service can subscribe. The services publish fulfilled intents. Fulfilled intents are the relevance that a service delivers in one common way. The service can use the Services Registry to register the intents the service can publish and to register the intents to which the service wants to subscribe. An intent can use existing intents; using core intents is the quickest way to add a new intent. The Abstract Domain Services break a complex intent into atomic intents and publish the atomic intents to vertical or specialist services for fulfillment. The Abstract Domain Services orchestrate the fulfilled atomic intents to fulfill a complex intent.

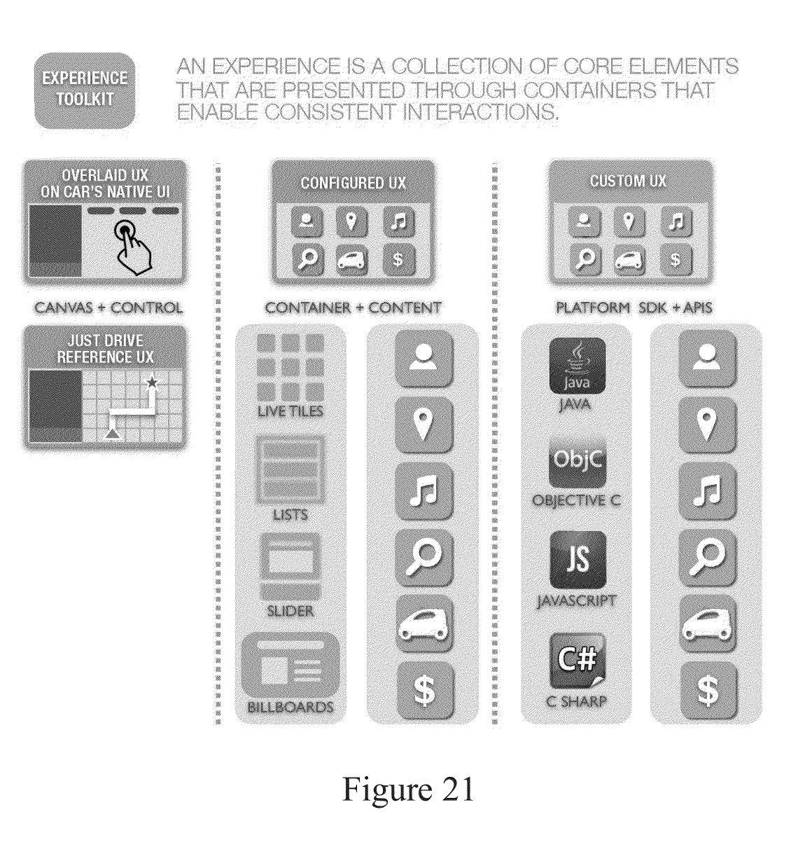

FIG. 21 illustrates the experience structure of an example embodiment enabling the creation of custom user interfaces. A User Interface (UX) ToolKit enables OEMs to overlay, configure, or create custom experiences using common elements. OEMs use the UX Toolkit to create branded experiences. The default user interface experience can be overlaid on a native vehicle user interface, and OEMs can configure how various services get invoked (e.g., a long press, special key, etc.) by the user. Proactive push user interface elements (e.g., sliders) get focus when overlaid. The default user interface experience can be configured through widgets by customization of the widget's Containers, Contents, and Transitions. The Container properties of the widget include size, color, number, and types of elements. The Content of the widget belongs to a Domain and a Topic. The Content properties of the widget include number, order (e.g., recent, frequent, last used), and actions. Transitions control how and when a Container gets presented or removed. For OEMs who want to go beyond configuring a basic user interface, the OEMs can use the appropriate platform software development kit (SDK) to create custom experiences that leverage the smart vehicle platform application programming interfaces (APIs) provided by the example embodiment. The smart vehicle platform APIs are accessible through all platform SDKs. The platform SDK enables the complete set of APIs to the smart vehicle platform user interface elements (e.g., People, Places, Media, Search, Telemetry and Transactions) to be accessed from Java, Objective C, C Sharp and JS/HTML5 applications (apps). Java, Objective C, C Sharp and JS/HTML5 are well-known to those of ordinary skill in the art.

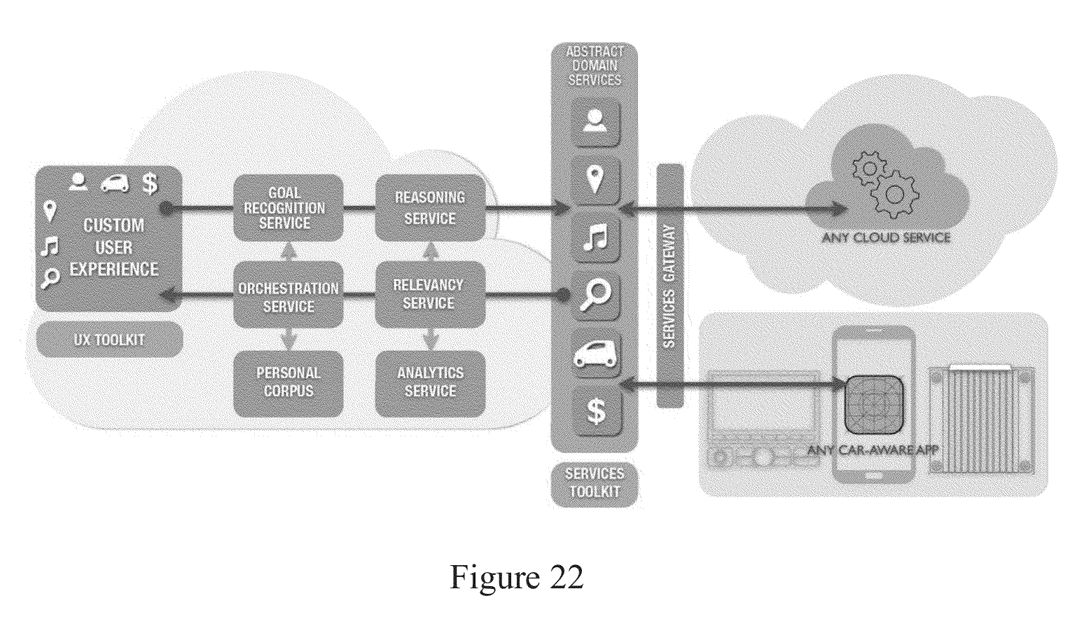

FIG. 22 illustrates the smart vehicle platform of an example embodiment. As shown, a services gateway enables the Abstract Domain Services to access services located in the network cloud, in a vehicle-aware application in a mobile device, or in a vehicle-resident application. As described above, a custom user interface experience can be developed by OEMs using the customized widgets or the smart vehicle platform APIs provided by the example embodiment. As also described above, the custom user interface can send and receive intents to/from the Abstract Domain Services to realize the explicit or inferred actions of the user.

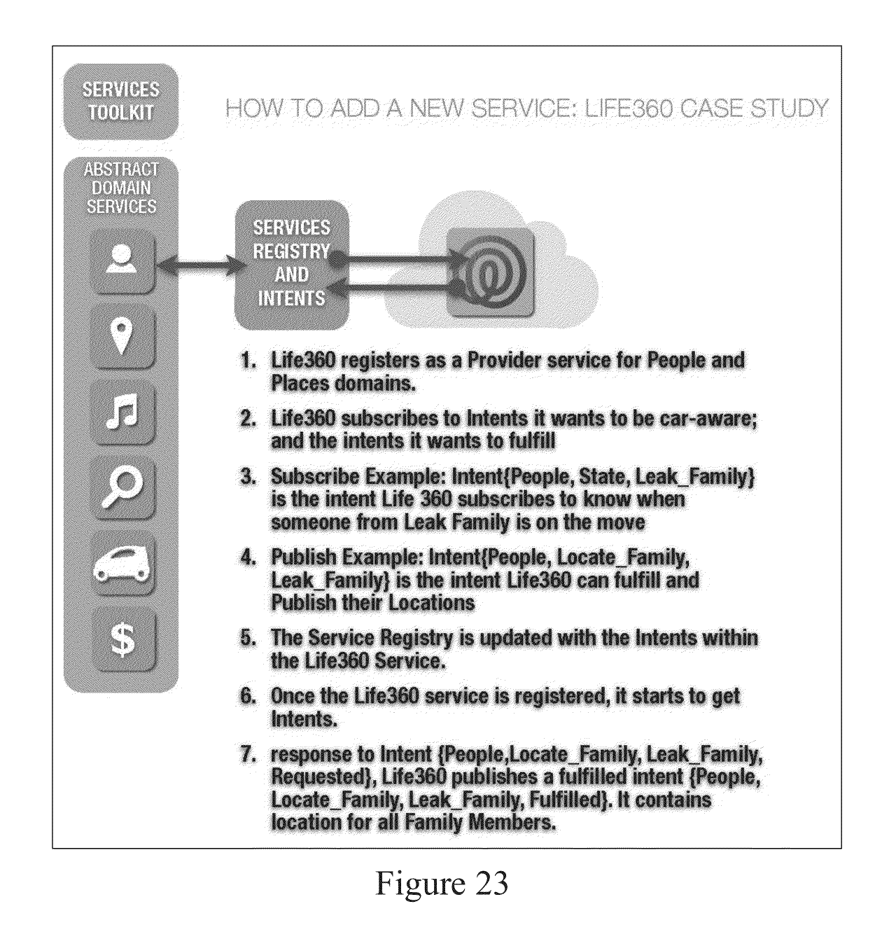

FIG. 23 illustrates an example of adding a service in an example embodiment. In the example embodiment, any service can be added to the platform of the example embodiment using the Services Registry as described above. As an example of adding a particular service, FIG. 23 illustrates an example of adding a service called Life360. Life360, for example, is a family-centric app that enables family members to exchange messages and track their locations. In the example provided, Life360 registers as a partner service. A code example in an example embodiment is set forth below:

```
class providerClasses. Life360Provider
intentPeopleFindName: (data) > # use life360 api calls
  return intentPeopleFindNameResponse
intentPlacesNavigateContact: (data) > # use life360 api
  return intentPlacesNavigateContactResponse
```

The Life360 partner service subscribes to the intents the service can fulfill. For example:

intentPeopleFindName

The Services Registry updates Life360 as a provider for the subscribed intents. A code example in an example embodiment is set forth below:

{
″intentPeopleFindFamily″: [
″Life360Provider″],
″intentPlacesNavigateContact″: [
″Life360Provider″,
″FourSquareProvider″ ]
}

The Services Registry updates the Goal Recognizer (IntentMapper) to require the new mapper. A code example in an example embodiment is set forth below:

# Require a reference to all of the providers

require(_dirname+‘/life360provider’)

Life360 publishes a fulfilled intent. A code example in an example embodiment is set forth below:

{
″intentPeopleFindFamilyFulfilled″: ″Life360Provider″,
″results″: [
{
″name″: ″Bruce Smith″,
″lat″: −122.1,
″long″: 36
},
{
″name″: ″Sandra″,
″lat″: −122.2,
″long″: 35.1
},
{
″name″: ″Max″,
″lat″: −121.9,
″long″: 35.6
}
]

These examples illustrate how the orchestration system of an example embodiment can evaluate and determine the information/content to present to a driver in a current context, evaluate and determine how to present the information/content, determine where to present the information/content, and determine when to present the information/content. The orchestration system of an example embodiment can orchestrate the information/content presented to the driver in a moving vehicle while monitoring and maintaining a current driver workload in a current context within pre-defined safe thresholds. Thus, a system and method to orchestrate in-vehicle experiences to enhance safety are disclosed.

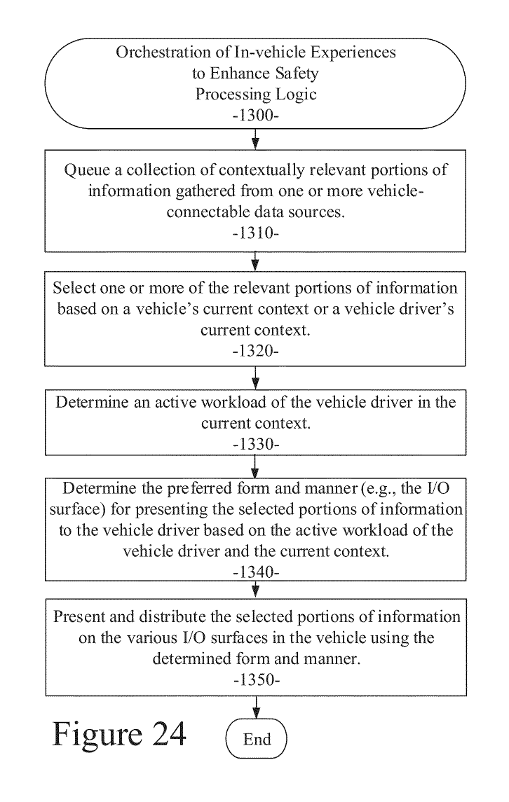

FIG. 24 is a processing flow diagram illustrating an example embodiment of a system and method 1300 to orchestrate in-vehicle experiences to enhance safety as described herein. The method 1300 of an example embodiment includes: queuing a collection of contextually relevant portions of information gathered from one or more vehicle-connectable data sources (processing block 1310); selecting one or more of the relevant portions of information based on a vehicle's current context or a vehicle driver's current context (processing block 1320); determining an active workload of the vehicle driver in the current context (processing block 1330); determining a preferred manner for presenting the selected portions of information to the vehicle driver based on the active workload of the vehicle driver and the current context (processing block 1340); and presenting the selected portions of information to the vehicle driver using the determined preferred manner (processing block 1350).

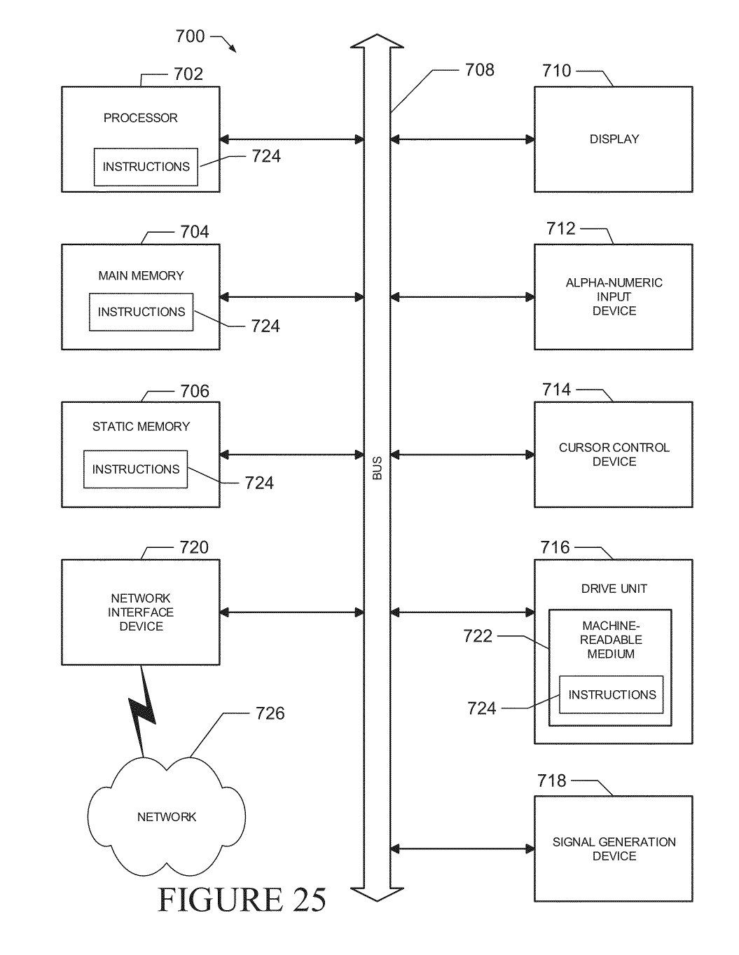

FIG. 25 shows a diagrammatic representation of machine in the example form of a computer system 700 within which a set of instructions when executed may cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” can also be taken to include any collection of machines that individually or jointly execute a set (or multiple sets) of instructions to perform any one or more of the methodologies discussed herein.

The example computer system 700 includes a data processor 702 (e.g., a central processing unit (CPU), a graphics processing unit (GPU), or both), a main memory 704 and a static memory 706, which communicate with each other via a bus 708. The computer system 700 may further include a display unit 710 (e.g., a liquid crystal display (LCD) or a cathode ray tube (CRT), or the like). The computer system 700 also includes an input device 712 (e.g., a keyboard), a cursor control device 714 (e.g., a mouse), a disk drive unit 716, a signal generation device 718 (e.g., a speaker) and a network interface device 720.

The disk drive unit 716 includes a non-transitory machine-readable medium 722 on which is stored one or more sets of instructions (e.g., software 724) embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over a network 726 via the network interface device 720. While the machine-readable medium 722 is shown in an example embodiment to be a single medium, the term “machine-readable medium” should be taken to include a single non-transitory medium or multiple media (e.g., a centralized or distributed database, and/or associated caches and servers) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An in-vehicle orchestration system comprising:
one or more data processors; and
an orchestration module, executable by the one or more data processors, to:
queue a collection of contextually relevant portions of information gathered from one or more vehicle-connectable data sources;
select one or more of the relevant portions of information based on a vehicle's current context or a vehicle driver's current context;
determine an active workload of the vehicle driver in the current context;
determine a preferred manner for presenting the selected portions of information to the vehicle driver based on the active workload of the vehicle driver and the current context; and
present the selected portions of information to the vehicle driver using the determined preferred manner.

2. The system as claimed in claim 1 wherein the one or more vehicle-connectable data sources include an application on a mobile device of the driver, a network-connectable site, a third party service, an object of physical infrastructure, or a subsystem of the vehicle.

3. The system as claimed in claim 1 being further configured to extract actions that can be taken on the selected portions of information and to select a primary action based on the current context.

4. The system as claimed in claim 1 being further configured to transform or normalize the selected portions of information for homogeneous consumption.

5. The system as claimed in claim 1 being further configured to pull information using an application programming interface (API).

6. The system as claimed in claim 1 wherein the current context is based on the driver's temporal context, geographical context, system state, and activity context.

7. The system as claimed in claim 1 being further configured to determine and prioritize the selected portions of information that need to be presented to the driver and to differentiate from the information that should be suppressed or delayed based on the current context.

8. The system as claimed in claim 1 being further configured to use assistive patterns to push information to the driver.

9. The system as claimed in claim 1 being further configured to determine an active workload of the vehicle driver in the current context by determining the activities in which the driver is currently involved and processing information from a vehicle subsystem or detection of a particular vehicle state.

10. A method comprising:
queuing a collection of contextually relevant portions of information gathered from one or more vehicle-connectable data sources;
selecting one or more of the relevant portions of information based on a vehicle's current context or a vehicle driver's current context;
determining an active workload of the vehicle driver in the current context;
determining a preferred manner for presenting the selected portions of information to the vehicle driver based on the active workload of the vehicle driver and the current context; and
presenting the selected portions of information to the vehicle driver using the determined preferred manner.

11. The method as claimed in claim 10 wherein the one or more vehicle-connectable data sources include an application on a mobile device of the driver, a network-connectable site, a third party service, an object of physical infrastructure, or a subsystem of the vehicle.

12. The method as claimed in claim 10 including extracting actions that can be taken on the selected portions of information and selecting a primary action based on the current context.

13. The method as claimed in claim 10 including transforming or normalizing the selected portions of information for homogeneous consumption.

14. The method as claimed in claim 10 including pulling information using an application programming interface (API).

15. The method as claimed in claim 10 wherein the current context is based on the driver's temporal context, geographical context, system state, and activity context.

16. The method as claimed in claim 10 including determining and prioritizing the selected portions of information that need to be presented to the driver and differentiating from the information that should be suppressed or delayed based on the current context.

17. The method as claimed in claim 10 including using assistive patterns to push information to the driver.

18. The method as claimed in claim 10 including determining an active workload of the vehicle driver in the current context by determining the activities in which the driver is currently involved and processing information from a vehicle subsystem or detection of a particular vehicle state.

19. A non-transitory machine-useable storage medium embodying instructions which, when executed by a machine, cause the machine to:
queue a collection of contextually relevant portions of information gathered from one or more vehicle-connectable data sources;
select one or more of the relevant portions of information based on a vehicle's current context or a vehicle driver's current context;
determine an active workload of the vehicle driver in the current context;
determine a preferred manner for presenting the selected portions of information to the vehicle driver based on the active workload of the vehicle driver and the current context; and
present the selected portions of information to the vehicle driver using the determined preferred manner.

20. The machine-useable storage medium as claimed in claim 19 wherein the one or more vehicle-connectable data sources include an application on a mobile device of the driver, a network-connectable site, a third party service, an object of physical infrastructure, or a subsystem of the vehicle.
